(19) United States
(12) Patent Application Publication
(10) Pub. No.: US 2025/0085770 A1
(43) Pub. Date: Mar. 13, 2025

(54) POWER MONITORING AND LIMITING OF PROCESSING UNITS (PUs) IN A PROCESSOR-BASED SYSTEM TO LIMIT OVERALL POWER CONSUMPTION OF THE PROCESSOR-BASED SYSTEM

(71) Applicant: QUALCOMM Incorporated, San Diego, CA (US)

(72) Inventors: Louis Louie, San Diego, CA (US); Ronald Alton, Oceanside, CA (US); Sumarlin William, San Diego, CA (US)

(21) Appl. No.: 18/463,557

(22) Filed: Sep. 8, 2023

(51) Int. Cl. G06F 1/329

(52) U.S. Cl. CPC G06F 1/329

(57) ABSTRACT

Power monitoring and limiting of processing units in a processor-based system to limit the overall power consumption of the processor-based system. In exemplary aspects, to limit the overall power consumption of the processor-based system while attempting to achieve an optimized performance of all the processing units, an overall power limit budget is allocated for the processing units (“processing unit power limit budget”). The processor-based system is configured to dynamically determine a total processing unit power limit budget available for the processing units based on remaining overall power available not consumed by other power consuming circuits. The processor-based system is configured to allocate the total processing unit power limit budget for processing units, that is then allocated to the different processing units based on their variances in workloads to try to achieve an optimal performance of the processing units while keeping the processor-based system within its overall power consumption limit.

### BACKGROUND

### I. Field of the Disclosure

The field of the disclosure relates to a processor-based system that includes one or more processing units (e.g., a central processing unit(s) (CPU(s)), a graphic processing unit(s) (GPU(s)), and/or or a neural processing unit(s) (NPU(s)), and more particularly to power distribution to the processing units in the processor-based system.

### II. Background

Processor-based systems conventionally include a power management system that controls the supply of power to power rails supplying power to circuits for their operation. A processor-based system may also include multiple power rails each with an individually settable voltage level so that different voltage levels can be supplied in the system. Some circuits may require lower volage levels than other circuits for operation. Further, it may be desired to provide circuits whose power can be collapsed during idle times (e.g., a processor) on a different power rail or domain than other circuits that have a minimum voltage level (e.g., memory circuits). Further, a processor-based system may include a frequency and voltage scaling system that is configured to dynamically change or scale the frequency of clocked circuits and/or their voltage level for operation. A higher frequency results in a faster operation of a clocked circuit. However, a higher voltage level may be required to support operation at a higher frequency. Further, higher frequency and voltage operation results in increased power consumption. Other devices in the processor-based system may not need to be scaled in performance.

Heat is generated by circuits in the processor-based device as a result of energy losses from the powered operation of the circuits. A processor-based system may have a thermal, temperature limitation for operation. This thermal limit may be based on circuit performance criteria (e.g., a circuit will have a thermal limit at which performance starts to decrease), to extend battery life, and/or to maintain temperature within “skin limits.” For example, a processor-based device may be a wearable device or other device (e.g., a laptop computer) that is expected or designed to come into contact with a user's skin. The ambient temperature also affects the temperature of the processor-based device.

### SUMMARY OF THE DISCLOSURE

Aspects disclosed herein include power monitoring and limiting of PUs in a processor-based system to limit the overall power consumption of the processor-based system. Related methods of power monitoring and limiting of PUs in the processor-based system are also disclosed. Workloads executed by the PUs in the processor-based system can greatly vary over time such that their power consumption will also vary in kind. This causes variation in the overall power consumption of the processor-based system. However, power limiting an individual PU can reduce its performance in an undesired manner, or the PU may not execute workloads that cause it to consume power to the power limit. Thus, in exemplary aspects, to limit the overall power consumption of the processor-based system while attempting to still achieve an optimized performance of all the PUs in the processor-based system, an overall power limit budget is allocated for the PUs (“PU power limit budget”). In this regard, in exemplary aspects, the processor-based system is configured to dynamically determine a total PU power limit budget available for the PUs that remains available from unused power by other power consuming circuits for the processor-based system (e.g., non-PU devices) to be within an overall power consumption limit. The processor-based system is configured to allocate an overall or total PU power limit budget for PUs in the processor-based system, that is then allocated to the different PUs based on their variances in workloads to try to achieve an optimal performance of the PUs while keeping the processor-based system within its overall power consumption limit.

Overall power consumption of the processor-based system can be correlated to heat due to expected energy loss that can then be correlated to a thermal limit of the processor-based system. Thus, by monitoring and limiting the overall power consumption of the processor-based system and its PUs, the temperature of the processor-based system can be limited to balance overall average power consumption of the different systems in the processor-based system while staying within thermal limits of the processor-based system, while achieving optimal performance of the PUs. Limiting power consumption in the processor-based system can also achieve a desired overall workload performance in a sustainable manner since heat and temperature can degrade workload performance. Limiting power consumption in the processor-based system can also extend battery life as temperature can negatively affect battery performance and power supplying capacity. Limiting power consumption in the processor-based system can also limit the temperature of the processor-based device to avoid skin damage to a user from hot spots that may otherwise occur due to heat generated due to energy losses. For example, the processor-based system may be a wearable device or other device that is anticipated to be placed in contact with the user's skin, such as a laptop computer or extended reality (XR) device.

In other exemplary aspects, the processor-based system includes multiple PUS that perform workloads and thus consume power. These multiple PUs can include, as examples, a central PU (CPU), a graphics PU (GPU), and/or a neural signal processor (NSP). In exemplary aspects, to monitor and limit the overall power consumption of the processor-based system, the processor-based system includes a power limiter circuit that is configured to set up a power consumption budget (“power limit budget”) for the PUs to operate and execute workloads and provide a power consumption limit for the PUs. In an example, the power limit for the PUs (“PU power limit budget”) is based on reducing an overall power consumption limit for the processor-based system by the power consumption of other circuits and systems outside of the PUs in the processor-based system (e.g., power management circuit, network interface circuits, battery charging circuits, etc.). The power limiter circuit then uses this remaining power limit to determine a total processing power limit budget that is then allocated as individual power limit budgets for the different PUs to operate. The PU power limit budgets allocated to the different PUs can be based on the workloads being executed by the PUs. This is so that the total PU power limit budget is distributed to the different PUs based on their relative workload power demand to try to achieve optimal performance while keeping the total PU power consumption within the remaining PU power limit budget to maintain an overall power consumption limit for the processor-based system. For example, a performance monitor circuit(s) may be associated with the different PUs to provide workload information to the power limiter circuit. The power limiter circuit can then allocate (e.g., proportionally) the PU power limit budget to the different PUs.

In other exemplary aspects, as the PUs operate to execute their workloads in the processor-based system, the power limiter circuit is further configured to determine if a given PU is consuming less power than its allocated power limit budget. If so, the power limiter circuit can be configured to adjust and reallocate the PU power limit budget to the different PUs for operation. In this manner, another PU(s) may enjoy an increase in its respective power limit budget in case such is needed for enhanced performance. Also, as the PUs operate to execute their workloads in the processor-based system, in another example, the power limiter circuit is further configured to determine if a given PU is consuming more power than is its allocated power limit budget. If so, this means that such PU may be executing workloads that cause the PU to consume more power than the power limit budget allocated to such PU. In this scenario, in an example, the processor-based system can be configured to cause the performance of the PU(s) to be reduced or throttled (e.g., by causing a reduction in clocked frequency, throughput, and/or instructions processed per unit of time (e.g., through pipeline stalling)) so that the PU reduces its performance and thus reduces power consumption towards or under the power limit budget allocated to such PU. In an example, the processor-based system can be configured to generate signals to a separate performance throttling system in the processor-based system that is configured to throttle the performance of the PUs (e.g., a dynamic voltage frequency scaling (DVFS) circuit).

In another example, when the power limiter circuit allocates or reallocates the total PU power limit budget to the PUs, the power limiter circuit may also be configured to request an operating state change (e.g., change in clocked frequency and/or voltage) for the PUs. For example, if a power limit budget allocated to a PU has increased, the operating state for such PU may also need to be increased (e.g., increase clocked frequency and/or voltage) for such PU to operate at an increased performance level to allow power consumption to the increased power limit budget allocated to the PU. As another example, if a power limit budget allocated to a PU has decreased, the operating state for such PU may need to be decreased (e.g., decreased clocked frequency and/or voltage) for such PU to operate more efficiently at a reduced performance level that will reduce and/or maintain its power consumption within its allocated power limit budget.

The power limiter circuit can execute a state machine or other process that monitors and allocates power limit budgets to the PUs in the processor-based system on a continuous basis. In this regard, the power limiter circuit, on a continuous basis, can determine the total PU power limit budget based on the power consumption of outside circuits subtracted from overall power limit of the processor-based system. The power limiter circuit, on a continuous basis, can allocate a power limit budget for each of the PUs based on the remaining, total PU power limit budget from the overall power consumption limit of the processor-based system and the workload information of the PUs. The power limiter circuit, on a continuous basis, can then monitor the power consumption of the PUs to determine if any of the PUs are consuming power under their respective allocated power limit budgets, and if so, adjust and reallocate the total PU power limit budget to the PUs in case other PUs need additional power for performance. The power limiter circuit, on a continuous basis, can also monitor the power consumption of the PUs to determine if the PUs are consuming more power than their allocated power limit budgets, and if so, adjust and reallocate the total PU power limit budget to possibly be able to allocate additional power to the PU(s) that exceeded its power limit budget. In this manner, the power limiter circuit is continually optimizing the allocation of power limit budgets to the PUs to achieve an optimization of the overall, combined performance of all the PUs in the processor-based system and based on their individual workload demands, while still limiting the overall power consumption of the processor-based system.

In this regard, in one exemplary aspect, a power limiter circuit for limiting power consumption of a plurality of PUs in a processor-based system is provided. The power limiter circuit is configured to: (a) determine a total PU power limit budget based on a difference between an overall power limit for the processor-based system and a power usage in the processor-based system. The power limiter circuit is also configured to (b) receive a plurality of workload data indicating a workload activity of each PU of a plurality of the PUs. The power limiter circuit is also configured to (c) allocate a power limit budget from the total PU power limit budget for each PU of the plurality of PUs based on workload data of the plurality of workload data corresponding to each PU. The power limiter circuit is also configured to (d) cause power consumption by each PU of the plurality of PUs to be constrained within the allocated power limit budget determined for the PU. The power limiter circuit is also configured to (e) determine a difference between actual power consumption of each PU of the plurality of PUs and the power limit budget for each PU. The power limiter circuit is also configured to (f) reallocate a new power limit budget from the total PU power limit budget for each PU of the plurality of PUs based on the determined difference between the actual power consumption of each PU of the plurality of PUs and the power limit budget for each PU.

In another exemplary aspect, a method of limiting power consumption of a plurality of PUs in a processor-based system is provided. The method (a) determining a total PU power limit budget based on a difference between an overall power limit for the processor-based system and a power usage in the processor-based system. The method also comprises (b) receiving a plurality of workload data indicating a workload activity of each PU of a plurality of the PUs. The method also comprises (c) allocating a power limit budget from the total PU power limit budget for each PU of the plurality of PUs based on workload data of the plurality of workload data corresponding to each PU. The method also comprises (d) causing power consumption by each PU of the plurality of PUs to be constrained within the allocated power limit budget determined for the PU. The method also comprises (c) determining a difference between actual power consumption of each PU of the plurality of PUs and the power limit budget for each PU. The method also comprises (f) reallocating a new power limit budget from the total PU power limit budget for each PU of the plurality of PUs based on the determined difference between the actual power consumption of each PU of the plurality of PUs and the power limit budget for each PU.

In another exemplary aspect, a processor-based system is provided. The processor-based system comprises a plurality of non-PU power consuming devices. The processor-based system also comprises a plurality of PUs. The processor-based system also comprises a plurality of PU performance monitor circuits each configured to: monitor workload activity of a PU of the plurality of PUs, and generate workload data corresponding to the monitored workload activity of the PU of the plurality of PUs. The processor-based system also comprises a plurality of power monitoring circuits each configured to monitor actual power consumption of a PU of the plurality of PU. The processor-based system also comprises a plurality of power constraining circuits each configured to constrain power consumption of a PU of the plurality of PUs. The processor-based system also comprises a power limiter circuit. The power limiter circuit is configured to (a) determine a total PU power limit budget based on a difference between an overall power limit for the processor-based system and a power usage of the plurality of non-PU power consuming devices. The power limiter circuit is also configured to (b) allocate a power limit budget from the total PU power limit budget for each PU of the plurality of PUs based on the workload data corresponding to each PU. The power limiter circuit is also configured to (c) instruct each of the plurality of power constraining circuits to constrain the power consumption of a PU of the plurality of PUs within the allocated power limit budget for the PU. The power limiter circuit is also configured to (d) determine a difference between the actual power consumption of each PU of the plurality of PUs from the plurality of power monitoring circuits and the power limit budget for each PU. The power limiter circuit is also configured to (e) reallocate a new power limit budget from the total PU power limit budget for each PU of the plurality of PUs based on the determined difference between the actual power consumption of each PU of the plurality of PUs and the power limit budget for each PU.

### BRIEF DESCRIPTION OF THE FIGURES

FIG. 1 is a block diagram of an exemplary processor-based system that includes power consuming circuits and processing units (PUs), and also includes a power-limiting (PL) circuit configured to determine a total PU power limit budget available to the PUs based on remaining power available to maintain the processor-based system within its overall power consumption limit, and allocate the total PU power limit budget to the PUs to control their power consumption based on their workloads being executed;

FIG. 2 is a block diagram of an exemplary processor-based system and power limiter circuit illustrating exemplary components associated with the allocation and reallocation of the determined total PU power limit budget available to the PUs based on remaining power available to maintain the processor-based system within its overall power consumption limit, and based on their workloads being executed by the PUs;

FIG. 3 is a flowchart illustrating an exemplary process of the power limiter circuit in FIGS. 1 and 2 determining a total PU power limit budget available to the PUS based on remaining power available to maintain the processor-based system within its overall power consumption limit, and allocate and reallocate the total PU power limit budget to the PUs to control their power consumption based on their workloads being executed;

FIG. 4 is a power consumption graph illustrating an exemplary time-based allocation and reallocation by a power limiter circuit of a determined total PU power limit budget to PUs in the processor-based systems in FIGS. 1 and 2, based on the workloads being executed by the PUs, while maintaining the processor-based system within its overall power consumption limit;

FIG. 5 is a flowchart illustrating another exemplary process of the power limiter circuit in FIGS. 1 and 2 determining a total PU power limit budget available to the PUs based on remaining power available to maintain the processor-based system within its overall power consumption limit, and allocate and reallocate the total PU power limit budget to the PUs to control their power consumption based on their workloads being executed;

FIG. 6 is an exemplary state machine diagram illustrating the enabling and disabling of the power limiter circuit determining a total PU power limit budget available to the PUs based on remaining power available and allocating the total PU power limit budget to the PUs to control their power consumption based on an activity state of a processor-based system;

FIG. 7 is a block diagram of an exemplary thermal management system that can be provided in the processor-based system in FIGS. 1 and 2 to monitor the temperature in the processor-based system and to manage devices and PUs in the processor-based system to enforce thermal limits;

FIG. 8 is a block diagram of an exemplary processor-based system that includes a power limiter circuit configured to determine a total PU power limit budget available to the PUs based on remaining power available to maintain the processor-based system within its overall power consumption limit, and allocate the total PU power limit budget to the PUs to control their power consumption based on their workloads being executed, and according to any of the exemplary processes in FIGS. 3, 5, and 6, and that can include, but is not limited to, the processor-based system and power limiter circuit in FIGS. 1 and 2; and

FIG. 9 is a block diagram of an exemplary wireless communications device that includes radio-frequency (RF) components that can include a processor-based system that includes a power limiter circuit configured to determine a total PU power limit budget available to the PUs based on remaining power available to maintain the processor-based system within its overall power consumption limit, and allocate the total PU power limit budget to the PUs to control their power consumption based on their workloads being executed, and according to any of the exemplary processes in FIGS. 3, 5, and 6, and that can include, but is not limited to, the processor-based system and power limiter circuit in FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include power monitoring and limiting of processing units (PUs) in a processor-based system to limit the overall power consumption of the processor-based system. Related methods of power monitoring and limiting of PUs in the processor-based system are also disclosed. Workloads executed by the PUs in the processor-based system can greatly vary over time such that their power consumption will also vary in kind. This causes variation in the overall power consumption of the processor-based system. However, power limiting an individual PU can reduce its performance in an undesired manner, or the PU may not execute workloads that cause it to consume power to the power limit. Thus, in exemplary aspects, to limit the overall power consumption of the processor-based system while attempting to still achieve an optimized performance of all the PUs in the processor-based system, an overall power limit budget is allocated for the PUs (“PU power limit budget”). In this regard, in exemplary aspects, the processor-based system is configured to dynamically determine a total PU power limit budget available for the PUs that remains available from unused power by other power consuming circuits (e.g., non-PU devices) for the processor-based system to be within an overall power consumption limit. The processor-based system is configured to allocate an overall or total PU power limit budget for PUs in the processor-based system, that is then allocated to the different PUs based on their variances in workloads to try to achieve an optimal performance of the PUs while keeping the processor-based system within its overall power consumption limit.

Overall power consumption of the processor-based system can be correlated to heat due to expected energy loss than can then be correlated to a thermal limit of the processor-based system. Thus, by monitoring and limiting the overall power consumption of the processor-based system and its PUs, the temperature of the processor-based system can be limited to balance overall average power consumption of the different systems in the processor-based system while staying within thermal limits of the processor-based system, while achieving optimal performance of the PUs. Limiting power consumption in the processor-based system can also achieve a desired overall workload performance in a sustainable manner since heat and temperature can degrade workload performance. Limiting power consumption in the processor-based system can also extend battery life as temperature can negatively affect battery performance and power supplying capacity. Limiting power consumption in the processor-based system can also limit the temperature of the processor-based device to avoid skin damage to a user from hot spots that may otherwise occur due to heat generated due to energy losses. For example, the processor-based system may be a wearable device or other device that is anticipated to be placed in contact with the user's skin, such as a laptop computer or extended reality (XR) device.

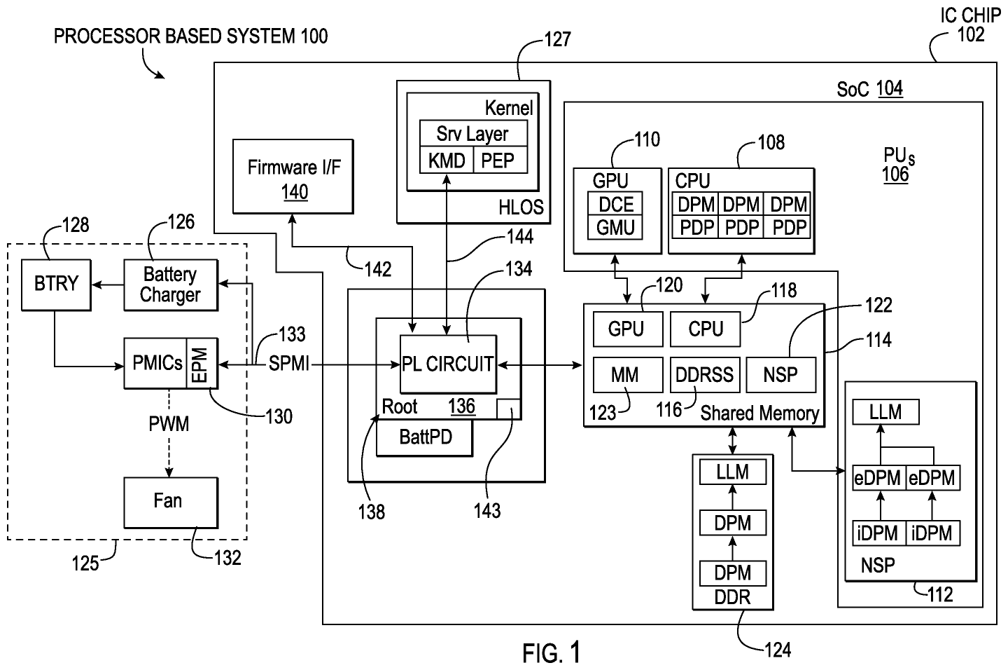

In this regard, FIG. 1 is a block diagram of an exemplary processor-based system 100 that includes power consuming circuits and processing units (PUs) in which it may be desired to limit the overall power consumption. The processor-based system 100 includes an integrated circuit (IC) chip 102 in this example, which is a system-on-a-chip (SoC) 104. The SoC 104 in this example includes multiple PUs 106, which in this example are a central PU (CPU) 108, a graphics PU (GPU) 110, and a neural PU (NPU) 112 that are each configured to execute instructions to perform respective workloads. Thus, the PUs 106 consume power to operate. In this example, the SoC 104 includes a shared memory system 114 that can be accessed by each of the PUs 106 for storage and retrieval of data for executing instructions. The shared memory system 114 may be a cache memory, such as a last-level cache memory, as examples. The shared memory system 114 in this example has a shared memory 116 that is generally accessible by each of the PUs 106. The shared memory system 114 may also have a memory management unit (MMU) configured to manage access to the shared memory 116. The shared memory system 114 may also have statically configured memory regions, namely a CPU memory region 118, a GPU memory region 120, a NPU memory region 122, and a multi-media region 123 to provide dedicated memory for the respective CPU 108, GPU 110, NPU 112, and a multi-media system. The SoC 104 in this example also includes a system memory 124 that is also accessible by the PUs 106 through the shared memory system 114 that has memory sufficient for the entire memory map of the PUs 106.

With continuing reference to FIG. 1, the processor-based system 100 also includes other devices outside of the SoC 104 and its PUs 106 that provide supporting functions including the supply of power to the SoC 104 and its PUs 106 for operation. These other devices are non-PU power consuming devices 125 that are outside the SoC 104 and its PUs 106 and are also electrical devices that are also power consuming in their own right. In this example, the processor-based system 100 includes a battery charging circuit 126 that is a circuit configured to charge a battery 128. The battery 128 is provided to supply power to the processor-based system 100 if the processor-based system 100 is not connected to a fixed power source. In this manner, the processor-based system 100 is configured to operate off of battery power as a power cordless device, such as in a mobile device. As also shown in FIG. 1, the processor-based system includes a power management IC (PMIC) 130 that is configured to manage the supply of power to the SoC 104 and other components of the processor-based system 100, such as a fan 132 for cooling. The PMIC 130 manages the battery charging circuit 126 to charge the battery 128 when the processor-based system 100 is connected to a power source. The PMIC 130 manages the discharge of the battery 128 to provide power when the processor-based system 100 is not connected to a power source.

Workloads executed by the PUs 106 in the processor-based system 100 can greatly vary over time such that their power consumption will also vary in kind. This causes variation in the overall power consumption of the processor-based system 100. However, power limiting an individual PU 106 can reduce its performance in an undesired manner, or the PU 106 may not execute workloads that cause it to consume power to the power limit. Overall power consumption of the processor-based system 100 can be correlated to heat due to expected energy loss than can then be correlated to a thermal limit of the processor-based system 100. Limiting power consumption in the processor-based system 100 can also limit temperature in the processor-based system 100 to avoid skin damage to a user from hot spots that may otherwise occur due to heat generated due to energy losses. For example, the processor-based system 100 may be included in a wearable device or other device that is anticipated to be placed in contact with the user's skin, such as a laptop computer or extended reality (XR) device.

Thus, as discussed in more detail below, to limit the overall power consumption of the processor-based system 100 while attempting to still achieve an optimized performance of all the PUs 106, the processor-based system 100 includes a power limiter circuit 134. The power limiter circuit 134 is configured to limit the power consumption of the PUs 106 in the processor-based system 100 based on a total power limit budget that is established for the PUs 106. In this example, the power limiter circuit 134 is not a current limiter that limits sudden changes in the rate of current flow (e.g., a derivative of current-di/dt), but rather constrains power consumption of the PUs 106. In this regard, as discussed below, the power limiter circuit 134 is configured to dynamically determine a total processing unit power limit budget available for the PUs 106. The total PU power limit budget is the power budget that remains available as unused power by the other power consuming circuits (e.g., non-PU devices) outside the PUs 106 from an overall power consumption limit of the processor-based system 100. The power limiter circuit 134 is configured to communicate with the battery charging circuit 126 and the PMIC 130 over a communication link 133 to determine their power consumption outside of the PUs 106, so that it can be determined how much power of the overall power consumption limit of the processor-based system 100 is being consumed. The remaining unused power of the overall power consumption limit of the processor-based system 100 can be allocated to the PUs 106 for operation. In this regard, the power limiter circuit 134 can be configured to allocate the total PU power limit budget remaining available to operate the PUs 106 into individual power limit budgets for each of the PUs 106 to be constrained for operation. The total PU power limit budget is allocated by the power limiter circuit 134 to the different PUs 106 based on their variances in workloads to try to achieve an optimal performance of the PUs 106 while keeping the processor-based system 100 within its overall power consumption limit. The power limiter circuit 134 is then configured to monitor the actual power consumption by the PUs 106 as well as their ongoing workloads and reallocate or adjust the power limit budgets of the PUs 106 for their operation.

For example, as discussed in more detail below, if the monitored actual power consumption by a PU 106 is under its allocated power limit budget, meaning the performance of such PU 106 does not demand the full power limit budget, the power limiter circuit 134 can be configured to decrease the power limit budget of such PU 106 and increase the power limit budget of another PU(s) 106 out of the total PU power limit budget. Also as an example, as also discussed in more detail below, if the monitored actual power consumption by a PU 106 exceeds its allocated power limit budget and/or the performance of such PU 106 is throttled performing at a level that would exceed its power limit budget, the power limiter circuit 134 can be configured to decrease the power limit budget of such PU 106 and increase the power limit budget of another PU(s) 106 out of the total processing unit power limit budget.

The power limiter circuit 134 can be configured to continuously allocate power limit budgets to the PUs 106 based on the respective workloads and to monitor and limit power consumption, and reallocate the power limit budgets to the PUs 106. In this manner, the power consumption of the processor-based system 100 can be controlled to remain within its thermal limits, while still achieving optimal performance of the PUs 106 based on their varying workload demands and reallocation of unused power budget. Limiting power consumption in the processor-based system 100 can also achieve a desired overall workload performance by the PUs 106 in a sustainable manner since heat and temperature can degrade workload performance. Limiting power consumption in the processor-based system 100 can also extend life of the battery 128 as temperature can negatively affect battery 128 performance and power supplying capacity. Limiting power consumption in the processor-based system 100 can also limit the temperature of a device that incorporates the processor-based system 100 to avoid skin damage to a user from hot spots that may otherwise occur due to heat generated due to energy losses. For example, the processor-based system 100 may be a wearable device or other device that is anticipated to be placed in contact with the user's skin, such as a laptop computer or extended reality (XR) device.

With continued reference to FIG. 1, in this example, the power limiter circuit 134 is a processing device that is configured to execute firmware or software instructions to perform the tasks of allocating power limit budgets to the PUs 106 and to monitor and limit power consumption, and reallocate the power limit budgets to the PUs 106. In this example, the power limiter circuit 134 includes a root memory 136 that is resident in the power limiter circuit 134 on the SoC 104 and includes a bootloader program 138 configured to be executed on boot-up or power-up of the SoC 104 and the power limiter circuit 134. The bootloader program 138, when executed by the power limiter circuit 134, is configured to communicate with a firmware interface 140 (e.g., a unified extensible firmware interface (UEFI)) over a communication link 142 to receive application firmware 143 to be executed by the power limiter circuit 134. In this manner, the application firmware that controls the operation of the power limiter circuit 134 can be programmable. The application firmware when executed by the power limiter circuit 134 can access configuration memory from the shared memory system 114. This configuration information can include the total power consumption limit for the processor-based system 100 that will be used by the power limiter circuit 134 to calculate the remaining available power limit budget available for the PUs 106 as discussed in more detail below. The power limiter circuit 134 can use the shared memory 116 for memory storage for faster access, including storing of calculated individual power limit budgets for the PUs 106.

As also shown in this example in FIG. 1, the processor-based system 100 also includes a high-level operating system (HLOS) 127. The HLOS 127 is configured to interface with the power limiter circuit 134 over a communication link 144 to communicate the overall power limit budget of the processor-based system 100 to the power limiter circuit 134. The power limiter circuit 134 may also be configured to communicate power budget messages and other information to the HLOS 127 over the communication link 144. For example, the power limiter circuit 134 may receive a workload data indicating the workload of the PUs 106 from the HLOS 127 over the communication link 144. As discussed above, and discussed in more detail below, the power limiter circuit 134 is configured to allocate the total PU power limit budget to the PUs 106 relative to the workloads to attempt to provide sufficient power for the performance demand according to such workloads.

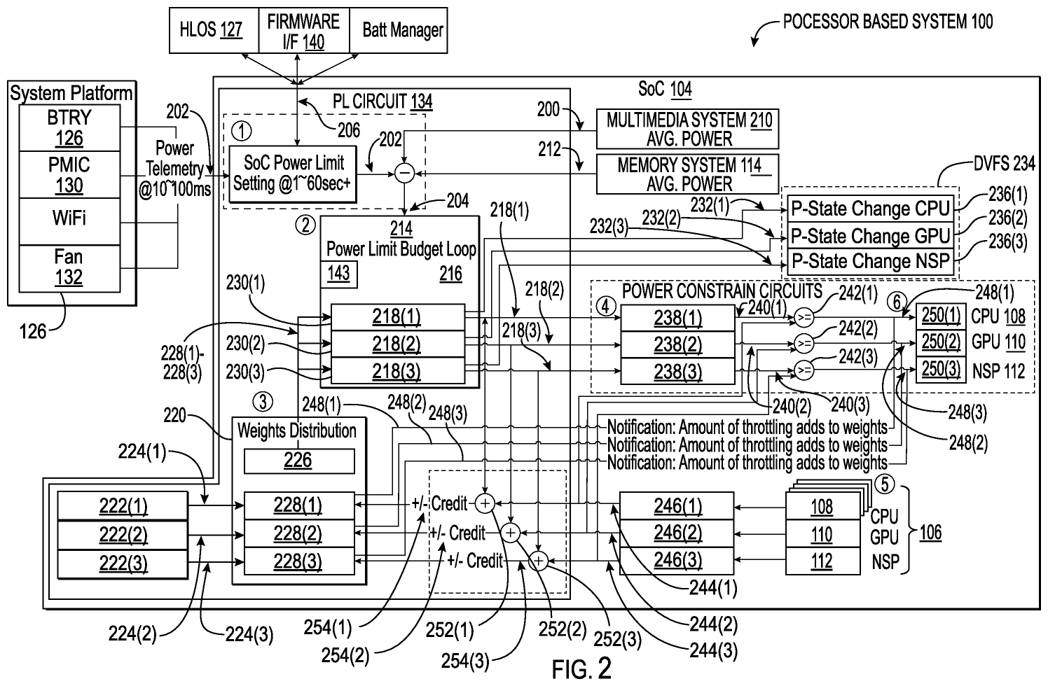

FIG. 2 is a block diagram illustrating more exemplary detail of portions of the exemplary processor-based system 100 and power limiter circuit 134 in FIG. 1 to further explain examples of allocating and reallocating a determined total PU power limit budget available to the PUs 106 based on remaining power available and their workloads to maintain the processor-based system 100 within its overall power consumption limit. As shown in FIG. 2, the power limiter circuit 134 is provided in the SoC 104. In this example, the power limiter circuit 134 includes a power limit budget determination circuit 200 that is configured to receive power telemetry data 202 indicating the power usage from non-PU devices 125 in the processor-based system 100. The power limit budget determination circuit 200 is configured to determine a total PU power limit budget 204 based on the difference between an overall power limit for the processor-based system 100 and the power usage of the other non-PU devices 125 in this example. In this manner, the power limiter circuit 134 is capable of determining how much power is available to power the SoC 104 and its PUs 106 such that the power consumption of the processor-based system 100 remains within its overall power limit. In this example, the power limit budget determination circuit 200 receives an overall power limit 206 for the processor-based system 100 through the firmware interface 140. The power limit budget determination circuit 200 subtracts the power usage of the non-PU devices 125 obtained from the power telemetry data 202 from the overall power limit 206 to be provided in the total PU power limit budget 204. The power limit budget determination circuit 200 in this example is also configured to subtract the average power consumption 208 of a multi-media system 210 and the average power consumption 212 of the shared memory system 114 in the processor-based system 100 from the overall power limit 206 of the processor-based system 100 as also consuming part of the overall power limit 206 for the processor-based system 100, to be provided in the total PU power limit budget 204. In this manner, the remaining total PU power limit budget 204 is the available power that can be consumed by the PUs 106 without the processor-based system 100 exceeding its overall power limit 206.

As an example, as discussed in more detail below, the power limiter circuit 134 may be configured such that the power limit budget determination circuit 200 calculates the total PU power limit budget 204 periodically, such as between one (1) to sixty (60) seconds. In this manner, the total PU power limit budget 204 that is used to constrain the power consumption of the PUs 106 is periodically and continuously updated so that unused power from reduced power consumption by the non-PU devices 125, the multi-media system 210, and/or the shared memory system 114 can become available to the PUs 106 as part of the total PU power limit budget 204. Likewise, if the non-PU devices 125, the multi-media system 210 and/or the shared memory system 114 consume more power, the total PU power limit budget 204 can be reduced so as to not exceed the overall power limit 206 of the processor-based system 100.

With continuing reference to FIG. 2, the power limiter circuit 134 in this example also includes a power limit budget circuit 214. The power limit budget circuit 214 is configured to execute the application firmware 143 to perform a power limit budget loop 216 for controlling the allocation and reallocation of power limit budgets 218(1)-218 (3) for the respective CPU 108, GPU 110, and NPU 112 such that the power consumption of these PUs 106 is constrained to their respective power limit budgets. For example, the power limit budget circuit 214 may be configured to perform the power limit budget loop 216 periodically between one (1) millisecond (ms) and ten (10) seconds depending on how often it is desired to change the power limit budgets 218(1)-218(3) to be used to constrain respective CPU 108, GPU 110, and NPU 112 power consumption. The power limit budgets 218(1)-218(3) used to by the power limiter circuit 134 to constrain power consumption of the PUs 106 is based on power consumption in the processor-based system 100 that is then used to generate the total PU power limit budget. The power limit budgets 218(1)-218(3) are not based on transient current draw or flow rate as a derivative or rate of change in current (e.g., di/dt). Thus, the power limit budget loop 216 for controlling the allocation and reallocation of the power limit budgets 218(1)-218 (3) for the respective CPU 108, GPU 110, and NPU 112 may not need to be executed as often as would be required to detect and make changes based on current flow rate. However, it is desired to execute the power limit budget loop 216 frequently enough so that any change in workload of the PUs 106 can be used to reallocate the total PU power limit budget 204 to optimize performance of the PUs 106 while not exceeding the overall power limit 206 of the processor-based system 100.

In this regard, the power limit budget circuit 214 is coupled to a power limit budget allocation circuit 220 that is configured to receive workload data 224(1)-224(3) indicating the workload of the respective CPU 108, GPU 110, and NPU 112. For example, the processor-based system 100 may include PU performance monitor circuits 222(1)-222(3) that are configured to monitor the workload activity of a respective CPU 108, GPU 110, and NPU 112 of the PUs 106. The PU performance monitor circuits 222(1)-222(3) are also configured to generate the respective workload data 224(1)-224(3) indicating the workload activity of the respective CPU 108, GPU 110, and NPU 112. In this manner, the power limit budget allocation circuit 220 can receive this workload data 224(1)-224(3) to have knowledge of the relative workload activity of the CPU 108, GPU 110, and NPU 112. The power limit budget allocation circuit 220 is configured to allow individual power budgets from the total PU power limit budget 204 to go to the CPU 108, GPU 110, and NPU 112 based on their respective workload activity from the respective workload data 224(1)-224(3). For example, the power limit budget allocation circuit 220 includes a power budget generation circuit 226 that is configured to allocate power budget weights 228(1)-228(3) corresponding to the respective CPU 108, GPU 110, and NPU 112 based on the workload activity of the CPU 108, GPU 110, and NPU 112. For example, if it is desired for the total PU power limit budget 204 to be allocated equally to the CPU 108, GPU 110, and NPU 112, the power budget generation circuit 226 can be configured to assign a weight of 33.33% to each of the power budget weights 228(1)-228(3). This may be an initial setting that is made by the power budget generation circuit 226 on reset or startup when workload data 224(1)-224(3) has not yet been received or not received for long enough to be stable. The power budget generation circuit 226 can be configured to allocate the power limit budgets 218(1)-218(3) (e.g., proportionally) using the power budget weights 228(1)-228(3) based on the relative workload data 224(1)-224(3). For example, the power budget generation circuit 226 can be configured to determine a percentage weight of the total PU power limit budget 204 for each PU 106 as a proportion of its workload activity from the workload data 224(1)-224(3) to a total workload activity of the PUs 106. The power budget generation circuit 226 is then configured to communicate or make available the power budget weights 228(1)-228(3) to the power limit budget circuit 214 to be used to allocate the power limit budgets 218(1)-218(3) for the PUs 106.

With continuing reference to FIG. 2, the power limit budget circuit 214 is configured to allocate the power limit budgets 218(1)-218(3) for the PUs 106 based on the power budget weights 228(1)-228(3). For example, the power budget weights 228(1)-228 (3) can be applied to the total PU power limit budget 204 so that that the total PU power limit budget 204 will be allocated to each of the PUs 106 based on their respective workload activity. As an example, the power limit budget circuit 214 may include power limit budget registers 230(1)-230(3) that are each configured to store the calculated power limit budgets 218(1)-218(3) to be applied to the PUs 106. The power limit budget circuit 214 can then access the power limit budget registers 230(1)-230(3) to perform the power limit budget loop 216 to constrain the power consumption of the PUs 106 based on the respective power limit budgets 218(1)-218(3).

With continuing reference to FIG. 2, the execution of the power limit budget loop 216 by the power limit budget circuit 214 causes the power consumption of the PUS 106 to be constrained within their determined power limit budgets 218(1)-218(3). In this regard, as shown in FIG. 2, if the determined power limit budget 218(1)-218(3) for a given PU 106 would require its operating point (i.e., clocked frequency and/or voltage) to be changed to achieve the power limit budget 218(1)-218(3), the power limit budget circuit 214 is configured to communicate a new operating point 232(1)-232(3) for a given respective CPU 108, GPU 110, or NPU 112 to a dynamic voltage frequency scaling (DVFS) circuit 234. The DVFS circuit 234 has a look-up table (LUT) 236(1)-236(3) corresponding to each of the CPU 108, GPU 110, and NPU 112 to look up a new operating point to operate the CPU 108, GPU 110, and NPU 112 based on the new operating point 232(1)-232(3) from the power limit budget circuit 214 based on its determined power limit budget 218(1)-218(3). As the power limit budgets 218(1)-218(3) are reallocated by the power limit budget circuit 214, the power limit budget circuit 214 can reset a new operating point 232(1)-232(3) for a given respective CPU 108, GPU 110, or NPU 112 to the DVFS circuit 234.

As this point, the power limiter circuit 134 and its supporting components has been described in terms of determining and allocating the power limit budgets 218(1)-218 (3) for the given respective CPU 108, GPU 110, or NPU 112 to constrain their respective power consumption. Now, the components and functionality in the power limiter circuit 134 and its supporting components in the SoC 104 are described in terms of constraining the power consumption of the respective CPU 108, GPU 110, or NPU 112 as well as adjusting and reallocating the power limit budgets 218(1)-218(3) for the given respective CPU 108, GPU 110, or NPU 112 based on the monitoring of their actual power consumption. The power limiter circuit 134 has the ability to reallocate the power limit budgets 218(1)-218(3) for the given respective CPU 108, GPU 110, or NPU 112 in the event that the actual power consumption of the CPU 108, GPU 110, or NPU 112 exceeds or is under its power limit budgets 218(1)-218(3) to prevent the processor-based system 100 from exceeding its overall power limit 206 while also achieving an optimal performance for the PUs 106. It is this feedback of the monitored actual power consumption as well as the monitoring of the workload data 224(1)-224(3) from the PUs 106 that allows the power limiter circuit 134 to continuously allocate and reallocate the power limit budgets 218(1)-218(3) in attempting to optimize performance of the PUs 106 while also maintaining the overall power consumption of the processor-based system 100 within the overall power limit 206.

In this regard, as shown in FIG. 2, the SoC 104 in this example, includes power constraining circuits 238(1)-238(3) that receive the respective power limit budgets 218(1)-218(3) from the power limit budget circuit 214. The power constraining circuits 238(1)-238(3) cause the power consumption of the respective CPU 108, GPU 110, or NPU 112 to be constrained according to the respective power limit budgets 218(1)-218 (3). The power constraining circuits 238(1)-238(3) are configured to generate power tracking indicators 240(1)-240(3) indicative of the constrained power consumption according to the respective power limit budgets 218(1)-218(3). The power constraining circuits 238(1)-238(3) are also configured to provide the power tracking indicators 240(1)-240(3) to respective power consumption differential circuits 242(1)-242(3), which are a type of comparator circuit. The power consumption differential circuits 242(1)-242 (3) also receive the actual power consumption 244(1)-244(3) of the respective CPU 108, GPU 110, and NPU 112 as measured by respective power monitoring circuits 246(1)-246(3). The actual power consumption 244(1)-244(3) may be the average actual power consumption of the respective CPU 108, GPU 110, and NPU 112 over a designated period of time. The power consumption differential circuits 242(1)-242(3) are configured to determine a difference between the actual power consumption 244(1)-244(3) of the respective CPU 108, GPU 110, or NPU 112 and the respective power limit budgets 218(1)-218(3) indicated by the power tracking indicators 240(1)-240(3) indicative of the constrained power consumption according to the respective power limit budgets 218(1)-218(3). The power consumption differential circuits 242(1)-242(3) are each configured to generate a performance throttle event 248(1)-248(3) based on the difference between the actual power consumption 244(1)-244(3) of the respective CPU 108, GPU 110, and NPU 112 and the power tracking indicators 240(1)-240(3) indicative of the power limit budgets 218(1)-218(3) of the respective CPU 108, GPU 110, and NPU 112. The power consumption differential circuits 242(1)-242(3) are configured to generate the respective performance throttle events 248(1)-248 ((3) to respective performance throttle circuits 250(1)-250(3) to throttle the performance of the respective CPU 108, GPU 110, and NPU 112 based on the performance throttle events 248(1)-248(3). The performance throttle circuits 250(1)-250(3) can be configured to throttle performance of a PU 106 by throttling (reducing) throughput or clocked frequency, as examples if the actual power consumptions 244(1)-244(3) exceed the power limit budgets 218(1)-218(3) indicated by the power tracking indicators 240(1)-240(3).

For example, if a PU's 106 actual power consumption 244(1)-244(3) exceeds its power limit budget 218(1)-218(3), the performance throttle event 248(1)-248(3) will cause the respective performance throttle circuit 250(1)-250(3) for the respective CPU 108, GPU 110, and NPU 112 to reduce its performance level, thus reducing its power consumption. If a PU's 106 actual power consumption 244(1)-244(3) does not exceed its power limit budget 218(1)-218(3), the performance throttle event 248(1)-248(3) will cause the respective performance throttle circuit 250(1)-250(3) for the respective CPU 108, GPU 110, and NPU 112 to potentially increase its performance level (e.g., un-throttle), thus allowing its power consumption to be increased according to its power limit budget 218(1)-218(3).

With continuing reference to FIG. 2, the performance throttle events 248(1)-248 (3) are also provided to the power limit budget allocation circuit 220. The power limit budget allocation circuit 220 is configured to reallocate the power budget weights 228(1)-228 (3) based on the determined difference between the respective actual power consumption 244(1)-244(3) and the respective power limit budgets 218(1)-218(3). The power limit budget allocation circuit 220 is configured to reallocate the power budget weights 228(1)-228(3) based on the performance throttle events 248(1)-248(3), so that any PUs 106 that had to be throttled will have their power budget weights 228(1)-228(3) reallocated (e.g., reduced). This is turn will cause the power limit budget circuit 214 to reallocate new power limit budgets 218(1)-218(3) accordingly. Thus, for example, if a PU 106 had to be throttled down in performance based on performance throttle events 248(1)-248(3), the power limit budget allocation circuit 220 can use this information to know that the power budget weight 228(1)-228(3) for such throttled PU 106 may be increased since it will be known that the power consumption of the PU 106 is exceeding its previous power limit budget 218(1)-218(3). In this manner, the power limit budget 218(1)-218(3) may be increased to allow the throttled PU 106 to be unthrottled such that the power consumption differential circuit 242(1)-242(3) will not determine the actual power consumption 244(1)-244(3) of the PU 106 exceeds its power tracking indicator 240(1)-240(3) indicating of its power limit budget 218(1)-218(3).

The power limit budget circuit 214 is configured to set a new operating point 232(1)-232(3) for a given respective CPU 108, GPU 110, or NPU 112 to the DVFS circuit 234 based on their respective allocated power budget weights 228(1)-228(3). If the determined reallocated power budget weights 228(1)-228(3) for a given PU 106 would require its operating point (i.e., clocked frequency and/or voltage) to be changed to achieve the power limit budget 218(1)-218(3), the power limit budget circuit 214 is configured to reset a new operating point 232(1)-232(3) for a given respective CPU 108, GPU 110, or NPU 112 to the DVFS circuit 234. As discussed above, the DVFS circuit 234 has the LUTs 236(1)-236(3) corresponding to each of the CPU 108, GPU 110, and NPU 112 to look up a new operating point to operate the CPU 108, GPU 110, and NPU 112 based on the new operating point 232(1)-232(3) from the power limit budget circuit 214 based on its determined power limit budget 218(1)-218(3). As the power limit budgets 218(1)-218(3) are reallocated by the power limit budget circuit 214, the power limit budget circuit 214 can reset a new operating point 232(1)-232(3) for a given respective CPU 108, GPU 110, or NPU 112 to the DVFS circuit 234.

With continuing reference to FIG. 2, the performance throttle events 248(1)-248 (3) are also provided to respective power consumption differential circuits 252(1)-252 (3) that are in the power limiter circuit 134 in this example. The power consumption differential circuits 252(1)-252(3) are each configured to compare the actual power consumption 244(1)-244(3) of the respective CPU 108, GPU 110, and NPU 112 determined by the respective power monitoring circuits 246(1)-246(3), with the power limit budgets 218(1)-218(3) from the power limit budget circuit 214. The power consumption differential circuits 252(1)-252(3) are each configured to generate a differential power signal 254(1)-254(3) to the power limit budget allocation circuit 220 indicating the difference between the actual power consumption 244(1)-244(3) of a respective CPU 108, GPU 110, or NPU 112 and its respective power limit budget 218(1)-218 (3).

If the difference between the actual power consumption 244(1)-244(3) of the respective CPU 108, GPU 110, or NPU 112 is determined by the respective power monitoring circuit 246(1)-246(3) to not exceed the respective power limit budget 218(1)-218 (3), the power limit budget allocation circuit 220 can use this information to know that the power budget weight 228(1)-228(3) for such PU 106 should be decreased. The power limit budget allocation circuit 220 can then reallocate that unused power budget to another PU(s) 106 in its respective power budget weight 228(1)-228(3). In this manner, another PU 106 can be given the unused power budget to further optimize its performance. If the difference between the actual power consumption 244(1)-244(3) of the respective CPU 108, GPU 110, or NPU 112 is determined by the respective power monitoring circuit 246(1)-246(3) to exceed the respective power limit budget 218(1)-218 (3), the power limit budget allocation circuit 220 can use this information to know that the power budget weight 228(1)-228(3) for such PU 106 should be increased if possible. The power limit budget allocation circuit 220 can then reallocate the power limit budget 218(1)-218(3) from another PU(s) 106, if available, in its respective power budget weight 228(1)-228(3). In this manner, the PU 106 whose actual power consumption 244(1)-244(3) exceeds it power limit budget 218(1)-218(3) can be given additional power budget to further optimize its performance.

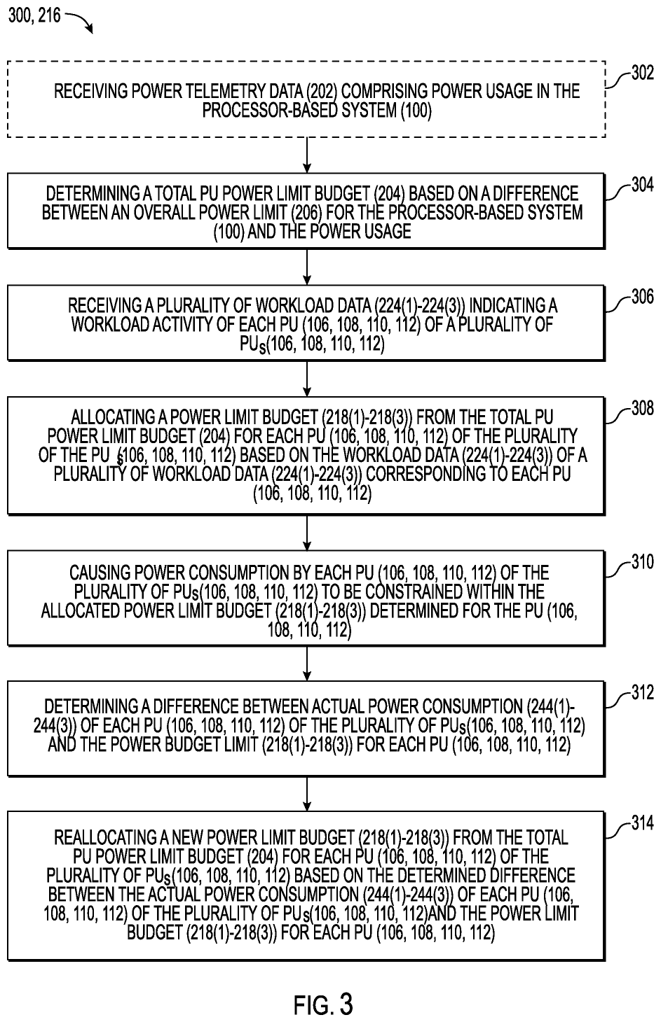

FIG. 3 is a flowchart illustrating an exemplary process 300 of the power limiter circuit 134 in FIGS. 1 and 2 that can be used as the power limit budget loop 216 to determine a total PU power limit budget 204 available to the PUs 106 based on remaining power available to maintain the processor-based system 100 within its overall power consumption limit, and allocate and reallocate the total PU power limit budget 204 to the PUs 106 to control their power consumption based on their workloads being executed.

In this regard, as shown in FIG. 3, a first step of the power limit budget loop 216 is receiving power telemetry data 202 comprising power usage in the processor-based system 100 (block 302 in FIG. 3). A next step in the power limit budget loop 216 can be determining a total PU power limit budget 204 based on a difference between an overall power limit 206 for the processor-based system 100 and the power usage (block 304 in FIG. 3). A next step in the power limit budget loop 216 can be receiving a plurality of workload data 224(1)-224(3) indicating a workload activity of each PU 106. 108, 110, 112 of a plurality of PUs 106, 108, 110, 112 (block 306 in FIG. 3). A next step in the power limit budget loop 216 can be allocating a power limit budget 218(1)-218(3) from the total PU power limit budget 204 for each PU 106, 108, 110, 112 of the plurality of PUs 106, 108, 110, 112 based on the workload data 224(1)-224(3) of a plurality of workload data 224(1)-224(3) corresponding to each PU 106, 108, 110, 112 (block 308 in FIG. 3). A next step in the power limit budget loop 216 can be causing power consumption by each PU 106, 108, 110, 112 of the plurality of PUs 106, 108, 110, 112 to be constrained within the allocated power limit budget 218(1)-218(3) determined for the PU 106, 108, 110, 112 (block 310 in FIG. 3). A next step in the power limit budget loop 216 can be determining a difference between actual power consumption 244(1)-244(3) of each PU 106, 108, 110, 112 of the plurality of PUs 106, 108, 110, 112 and the power limit budget 218(1)-218(3) for each PU 106, 108, 110, 112 (block 312 in FIG. 3). A next step in the power limit budget loop 216 can be reallocating a new power limit budget 218(1)-218(3) from the total PU power limit budget 204 for each PU 106, 108, 110, 112 of the plurality of PUs 106, 108, 110, 112 based on the determined difference between the actual power consumption 244(1)-244(3) of each PU 106, 108, 110, 112 of the plurality of PUs 106, 108, 110, 112 and the power limit budget 218(1)-218(3) for each PU 106, 108, 110, 112) (block 314 in FIG. 3).

The process 300 in FIG. 3 can be continuously repeated periodically (e.g., between every 1 ms and 1 second) to determine a total PU power limit budget 204 available to the PUs 106 based on remaining power available to maintain the processor-based system 100 within its overall power consumption limit, and allocate and reallocate the total PU power limit budget 204 to the PUs 106 to control their power consumption based on their workloads being executed. The process 300 in FIG. 3 can be repeated in response to expiration of a periodic timer set to expire after a constant amount of time and/or interrupt driven.

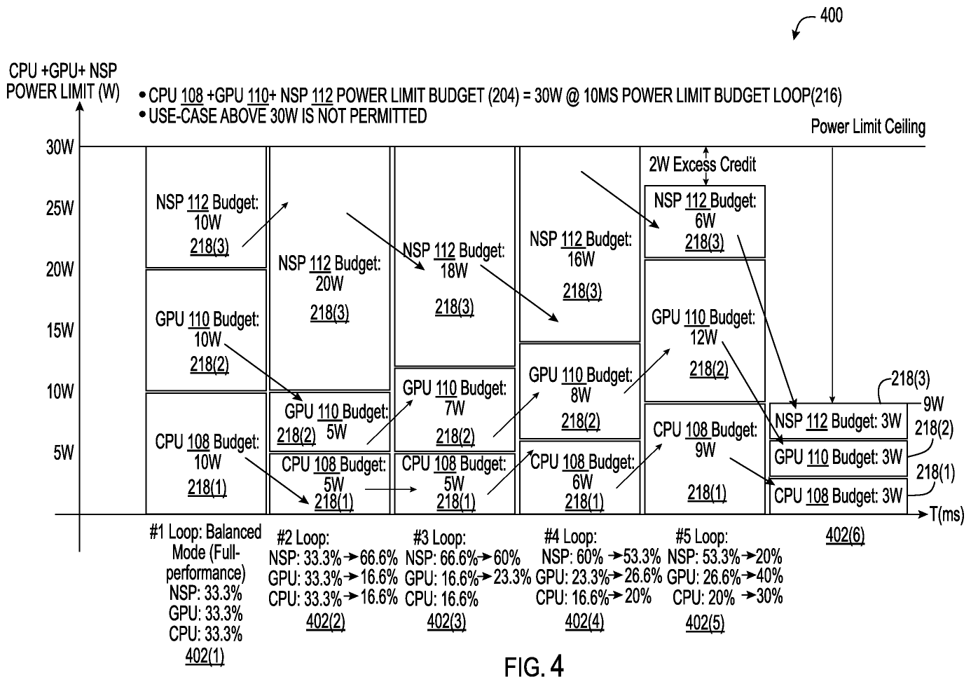

FIG. 4 is a power consumption graph 400 illustrating exemplary time-based allocation and reallocation by the power limiter circuit 134 in the processor-based system 100 in FIGS. 1 and 2 of the determined total PU power limit budget 204 to the PUs 106, based on the workloads being executed by the PUs 106, while maintaining the processor-based system 100 within its total PU power limit budget 204 of 30 Watts (W). The power limiter circuit 134 allocates the total PU power limit budget 204 to the PUs 106 based on operating the power limit budget loop 216 every ten (10) ms in this example.

In this regard, as shown in FIG. 4, in an example of a first iteration 402(1) of the power limit budget loop 216 by the power limit budget circuit 214 in the power limiter circuit 134, the power limit budget allocation circuit 220 initially allocates the power budget weights 228(1)-228(3) for the CPU 108, GPU 110, and NPU 112 based on a balanced mode wherein each power budget weight 228(1)-228(3) is 33.3%. Thus, the power limit budget circuit 214 allocates the power limit budgets 218(1)-218(3) for the CPU 108, GPU 110, and NPU 112 each of 10 W based on the power budget weights 228(1)-228(3) being applied to the total PU power limit budget 204 of 30 W. Then, in an example of a second iteration 402(2) of the power limit budget loop 216 in the graph 400 in FIG. 4, the power budget weights 228(1)-228(3) for the CPU 108, GPU 110, and NPU 112 are adjusted to 66.6%, 16.6%, and 16.6%, respectively, based on the workload data 224(1)-224(3) indicating that the NPU 112 has 66.6% of the total workload activity indicated by the total of the workload data 224(1)-224(3). The power limiter circuit 134 may set new operating points 232(1)-232(2) in the DVFS circuit 234 before the power limit budgets 218(1)-218(3) are allocated by the power limit budget circuit 214 so that the PUs 106 can operate at a performance level compatible with their allocated power limit budgets 218(1)-218(3). Setting the new operating points 232(1)-232(2) in the DVFS circuit 234 before the power limit budgets 218(1)-218(3) are reallocated may prevent immediately throttling of a PU 106 that may otherwise be allocated a power limit budget 218(1)-218(3) beyond its performance capability according to its operating point 232(1)-232 (3). The power limit budget circuit 214 allocates the power limit budgets 218(1)-218 (3) for the CPU 108, GPU 110, and NPU 112 of 5 W, 5 W and 20 W, respectively, based on the power budget weights 228(1)-228(3) being applied to the total PU power limit budget 204 of 30 W.

Then, in an example of a third iteration 402(3) of the power limit budget loop 216 in the graph 400 in FIG. 4, the power budget weights 228(1)-228(3) for the CPU 108, GPU 110, and NPU 112 are adjusted to 16.6%, 23.3% and, 60%, respectively, based on the workload data 224(1)-224(3) indicating that the NPU 112 has 60% of the total workload activity indicated by the total of the workload data 224(1)-224(3) and the GPU 110 has 23.3% of the total workload activity indicated by the total of the workload data 224(1)-224(3). The power limiter circuit 134 may set new operating points 232(1)-232(2) in the DVFS circuit 234 before the power limit budgets 218(1)-218(3) are allocated by the power limit budget circuit 214 so that the PUs 106 can at a performance level compatible with their allocated power limit budgets 218(1)-218(3), only if required. Thus, the power limit budget circuit 214 allocates the power limit budgets 218(1)-218(3) for the CPU 108, GPU 110, and NPU 112 of 5 W, 7 W and 18 W, respectively, based on the power budget weights 228(1)-228(3) being applied to the total PU power limit budget 204 of 30 W.

Then, in an example of a fourth iteration 402(4) of the power limit budget loop 216 in the graph 400 in FIG. 4, the power budget weights 228(1)-228(3) for the CPU 108, GPU 110, and NPU 112 are adjusted to 53.3%, 26.6% and 20%, respectively, based on the workload data 224(1)-224(3) indicating that the NPU 112 has 53.3% of the total workload activity indicated by the total of the workload data 224(1)-224(3) and the GPU 110 has 26.6% of the total workload activity indicated by the total of the workload data 224(1)-224(3). Thus, the power limit budget circuit 214 allocates the power limit budgets 218(1)-218(3) for the CPU 108, GPU 110, and NPU 112 of 6 W, 8 W and 18 W, respectively, based on the power budget weights 228(1)-228(3) being applied to the total PU power limit budget 204 of 30 W. In this example, the power limiter circuit 134 set new operating points 232(2), 232(3) in the DVFS circuit 234 for the GPU 110 and the NPU 112 before allocating their new power limit budgets 218(2), 218(3) higher than previously allocated in the third iteration 402(3) of the power limit budget loop 216. This is so immediate throttling of the GPU 112 and/or the NPU 112 may be avoided.

Then, in an example of a fifth iteration 402(5) of the power limit budget loop 216 in the graph 400 in FIG. 4, the power budget weights 228(1)-228(3) for the CPU 108, GPU 110, and NPU 112 are adjusted to 30%, 40% and 20%, respectively, based on the workload data 224(1)-224(3). The power limiter circuit 134 sets new operating points 232(1)-232(3) in the DVFS circuit 234 for the PUs 106. In this example, an excess credit of 2 W of the 30 W total PU power limit budget 204 exists as a result of the SoC 104 not consuming all of the power from the total PU power limit budget 204. The actual power consumption 244(1)-244(3) of the CPU 108, GPU 110, and NPU 112 is 9 W, 8 W, and 16 W, respectively. Then, in an example of a sixth iteration 402(6) of the power limit budget loop 216 in the graph 400 in FIG. 4, the power budget weights 228(1)-228(3) for the CPU 108, GPU 110, and NPU 112 are adjusted to be balanced to 33% each based on the workload data 224(1)-224(3). In this example, the SoC 104 is set to a power saving mode whereby the total PU power limit budget 204 is reduced from 30 W to 9 W. Thus, the power limit budgets 218(1)-218(3) of the CPU 108, GPU 110, and NPU 112 are set to 3 W each, which is an equal allocation of the 9 W available in the new total PU power limit budget 204.

Note that in an alternative example, the power limit budget circuit 214 could be configured to set the power limit budget 218(1)-218(3) for any of the PUs 106 at a fixed, set power limit budget (e.g., 50%) to the total PU power limit budget 204. Thus, in this example, the power limit budget circuit 214 will only be able to allocate and reallocate the remainder percentage (e.g., 50%) of the total PU power limit budget 204 to the other PUs 106 that do not have a fixed power limit budget 218(1)-218(3) setting.

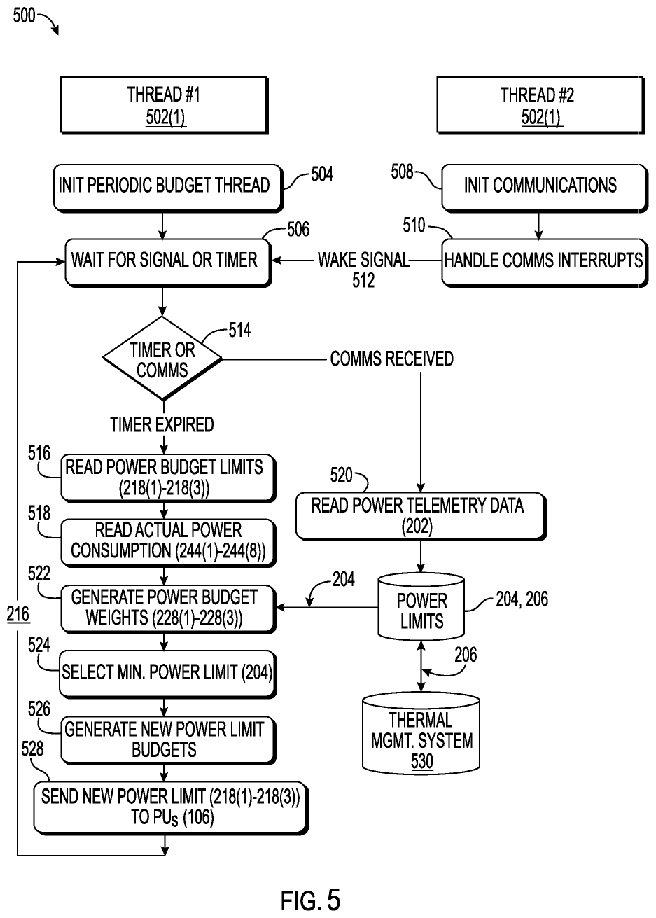

FIG. 5 is a flowchart illustrating another exemplary process 500 of the power limiter circuit 134 in FIGS. 1 and 2 determining a total PU power limit budget 204 available to the PUs 106 based on remaining power available to maintain the processor-based system 100 within its overall power limit 206, and allocate and reallocate the total PU power limit budget 204 to the PUs 106 to control their power consumption based on their workloads being executed. The process 500 in FIG. 5 can be a power limit budget loop 216 executed by the power limiter circuit 134. The process 500 in FIG. 5 can be executed as a result of two different threads 502(1), 502(2) in this example. The first thread 502(1) can be initiated on startup or reset of the power limiter circuit 134 and initialized (block 504 in FIG. 5) to then wait for the expiration of a timer set to expire after a constant period of time (block 506 in FIG. 5) to then execute the power limit budget loop 216. Alternatively, a second thread 502(2) can be initiated on startup or reset of the power limiter circuit 134 and initialized (block 508 in FIG. 5) and an interrupt generated (block 510 in FIG. 5) to generate a wake signal 512 to trigger ad hoc execution of the power limit budget loop 216 outside of its periodic execution controlled by the timer expiration (block 506 in FIG. 5). The power limit budget circuit 214 waits for either the timer expiration or wake signal 512 to then perform an iteration of the power limit budget loop 216 (block 514 in FIG. 5).

In this regard, as shown in FIG. 5, the power limit budget loop 216 in this example involves reading the existing power limit budgets 218(1)-218(3) for the PUs 106 to determine which of the power limit budgets 218(1)-218(3) has the most constraint (block 516 in FIG. 5). Then the power limit budget loop 216 reads the actual power consumption 244(1)-244(2) from the power monitoring circuits 246(1)-246(2) to be able to determine if the PUs 106 are consuming more or less power than their existing power limit budget 218(1)-218(3) (block 518 in FIG. 5). Also as shown in FIG. 5, the power limit budget loop 216 also involves the total PU power limit budget 204 being updated based on the total PU power limit budget 204 to establish the total PU power limit budget 204 (block 520 in FIG. 5). Then, the power limit budget loop 216 generates new power budget weights 228(1)-228(3) based on the workload activity of the PUs 106 from the workload data 224(1)-224(3) and the actual power consumption 244(1)-244(3) of the PUS 106 (block 522 in FIG. 5). The power limit budget loop 216 also, if necessary, adjusts the total PU power limit budget 204 if less than a minimum power limit needed to operate the PUs 106 (block 524 in FIG. 5). Then, the power limit budget circuit 214 allocates new power limit budgets 218(1)-218(3) based on the new power budget weights 228(1)-228 (3) (block 526 in FIG. 5), to then use to communicate to the power constraining circuits 238(1)-238(3) to constrain the power usage of the respective PUs 106 (block 528 in FIG. 5).

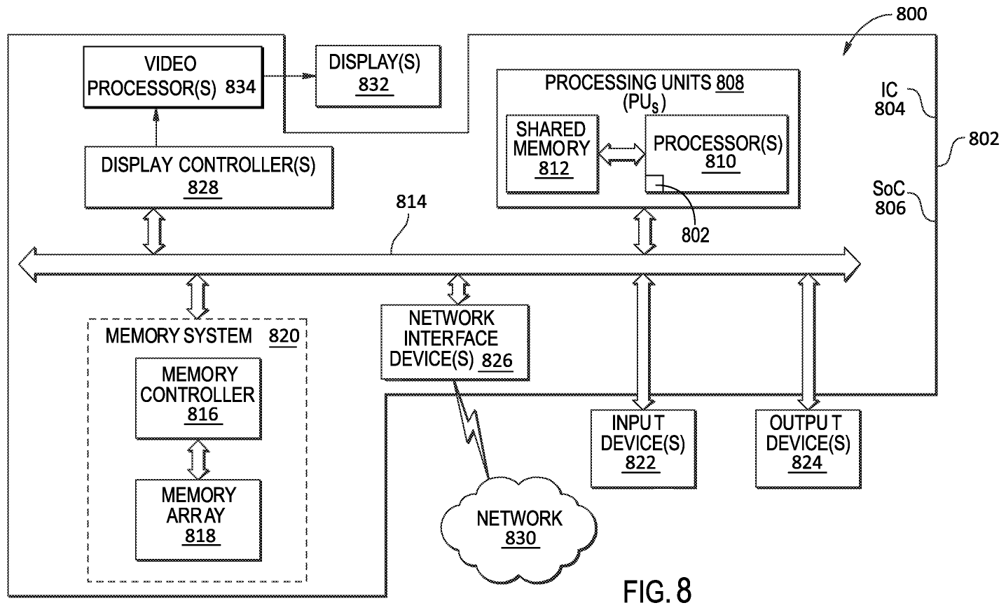

Note as shown in FIG. 5, the overall power limit 206 of the processor-based system 100 may be received from a separate thermal management system 530 that includes temperature sensors in the processor-based system 100 and SoC 104 to measure temperature and adjust the thermal limits of the processor-based system 100 in response. This can change the overall power limit 206 of the processor-based system 100 that is then used by the power limiter circuit 134 to allocate power limit budgets to the PUs 106. An example thermal management system 530 is discussed below with regard to FIG. 8.

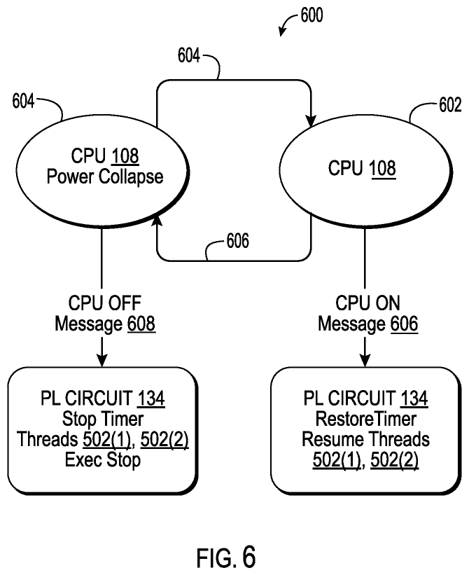

FIG. 6 is an exemplary state machine diagram 600 illustrating the enabling and disabling of the power limiter circuit 134 to enable and disable the thread 502(1), 502(2) in FIG. 5 to enable and disable the power limit budget loop 216. For example, state 602 in FIG. 6 is when the CPU 108 is active in the processor-based system 100 in FIGS. 1 and 2. When the CPU 108 transitions from an inactive operation state to an active operation state 602, the CPU 108 can generate a PU enable signal 606 that can be received by the power limiter circuit 134 to then restore a timer and resume the threads 502(1), 502(2) in FIG. 5 to execute the power limit budget loop 216. When the CPU 108 transitions from an active operation state to an inactive operation state 604, the CPU 108 can generate a PU disable signal 608 that can be received by the power limiter circuit 134 to then disable the timer and the threads 502(1), 502(2) in FIG. 5 to not execute the power limit budget loop 216.

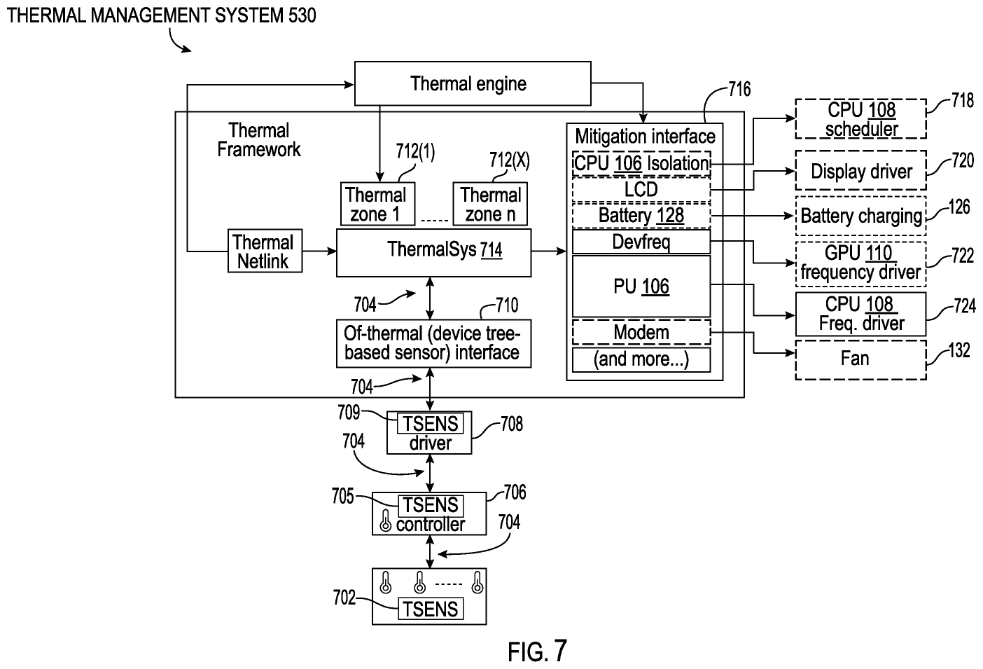

FIG. 7 is a block diagram of an exemplary thermal management system 530 referenced in FIG. 5 and that can be provided in the processor-based system 100 in FIGS. 1 and 2 to monitor the temperature in the processor-based system 100 and to manage devices and PUs 106 in the processor-based system 100 to enforce thermal limits. As shown in FIG. 7, the thermal management system 530 includes temperature sensors 702 that are placed in the processor-based system 100 and/or the SoC 104 to sense temperature. The temperature sensors 702 can be placed in known hot spots of the SoC 104 for example. As discussed above, the temperature of the processor-based system 100 can affect performance. The processor-based system 100 and its SoC 104 may have temperature limits for operation or skin limits. Power consumption affects temperature. The temperature sensors 702 provide temperature data 704 to a temperature controller 706, which can also include a temperature sensor(s) 705 that provides temperature data 704, but is also configured to receive temperature data 704 from remote temperature sensors 702. The temperature controller 706 can be configured to reset the SoC 104 and/or the processor-based system 100 if the temperature according to the temperature data 704 exceeds a maximum temperature programmed for the SoC 104 and/or the processor-based system 100. The thermal management system 700 also includes a temperature sensor driver circuit 708 that is configured to read the temperature data 704 from the temperature controller 706. A temperature sensor(s) 709 can also be associated with the temperature sensor driver circuit 708 that also provides temperature data 704. The temperature sensor driver circuit 708 is also configured to program the maximum temperature limit for the processor-based system 100 and/or the SoC 104 into the temperature controller 706.

With continuing reference to FIG. 7, the thermal management system 530 also includes an of—thermal interface circuit 710 that is configured to receive the temperature data 704 and aggregate temperature thresholds for multiple thermal zones 712(1)-712(X) in the processor-based system 100 and/or the SoC 104. The thermal management system 530 also includes a thermal system circuit 714 that resides in the HLOS 127 (see FIG. 1) and interfaces with each thermal zone 712(1)-712(X). There is a temperature sensor 702 associated with each thermal zone 712(1)-712(X). When the thermal system circuit 714 determines that a thermal limit for a thermal zone 712(1)-712 (X) has been exceeded, the thermal system circuit 714 is configured to perform a thermal mitigation task to reduce temperature. The thermal system circuit 714 is configured to control the various devices in the processor-based system 100 corresponding to the thermal zone 712(1)-712(X) exceeding its thermal limit through a mitigation interface circuit 716. The mitigation interface circuit 716 can then communicate to a device in the thermal zone 712(1)-712(X) to mitigate power consumption and/or to perform another task to reduce power consumption, which in turn will reduce temperature.

For example, as shown in FIG. 7, the thermal system circuit 714 may cause the CPU 108 scheduler 718 to reduce scheduling frequency of processes to reduce the workload activity of the CPU 108 to reduce power consumption if the thermal zone 712(1)-712(X) associated with the CPU 108 is exceeding its thermal limit. The thermal system circuit 714 may cause a display driver 720 to reduce its refresh rate to reduce power consumption if the thermal zone 712(1)-712(X) associated with the display driver 720 is exceeding its thermal limit. The thermal system circuit 714 may cause the battery charging circuit 126 to reduce its recharge rate to reduce power consumption if the thermal zone 712(1)-712(X) associated with the battery charging circuit 126 or its battery 128 is exceeding its thermal limit. The thermal system circuit 714 may cause the GPU 110 clock frequency driver circuit 722 to reduce its frequency rate to reduce power consumption in the GPU 110 if the thermal zone 712(1)-712(X) associated with the GPU 110 is exceeding its thermal limit. The thermal system circuit 714 may cause the CPU 108 clock frequency driver circuit 724 to reduce its frequency rate to reduce power consumption in the CPU 108 if the thermal zone 712(1)-712(X) associated with the CPU 108 is exceeding its thermal limit. The thermal system circuit 714 may cause the fan 132 to be activated or increase its fan speed to reduce temperature in the CPU 108 if a thermal zone 712(1)-712(X) is exceeding its thermal limit.

With each of the mitigation efforts that decrease power consumption in a PU 106, this will be reflected in the actual power consumption 244(1)-244(3) of such PU 106 that may in turn cause the power limiter circuit 134 in FIGS. 1 and 2 to reallocate its power limit budget 218(1)-218(3) in response. Even before the mitigation efforts are taken, if a thermal event is causing or caused by the actual power consumption 244(1)-244 (3) of a PU 106 exceeding its power limit budget 218(1)-218(3), the power limiter circuit 134 is configured to reallocate power limit budgets 218(1)-218(3) if possible as discussed above.

A processor-based system that includes a power limiter circuit configured to determine a total processing unit power limit budget available to the processing units based on remaining power available to maintain the processor-based system within its overall power consumption limit, and allocate the total processing unit power limit budget to the processing units to control their power consumption based on their workloads being executed, and according to any of the exemplary processes 300, 500, 600 in FIGS. 3, 5, and 6, and that can include, but is not limited to, the processor-based system 100 in FIGS. 1 and 2 and/or power limiter circuit 134 in FIGS. 1 and 2, and according to any aspects disclosed herein, may be provided in an IC package provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

In this regard, FIG. 8 illustrates an example of a processor-based system 800. The processor-based system 800 can include a power limiter circuit 802 configured to determine a total processing unit power limit budget available to the processing units based on remaining power available to maintain the processor-based system within its overall power consumption limit, and allocate the total processing unit power limit budget to the processing units to control their power consumption based on their workloads being executed, and according to any of the exemplary processes 300, 500, 600 in FIGS. 3, 5, and 6, and that can include, but is not limited to, the processor-based system 100 in FIGS. 1 and 2 and/or power limiter circuit 134 in FIGS. 1 and 2, and according to any aspects disclosed herein.

In this example, the processor-based system 800 may be formed as an IC 804 and as a system-on-a-chip (SoC) 806. The processor-based system 800 includes PUs 808 that include one or more processors 810, which can include a CPU, GPU, and NPU as examples. The PUs 808 may have a shared memory 812 (e.g., a shared cache memory) coupled to the PUs 808 for rapid access to temporarily stored data. The PUs 808 are coupled to a system bus 814 and can intercouple master and slave devices included in the processor-based system 800. As is well known, the PUs 808 communicate with these other devices by exchanging address, control, and data information over the system bus 814. For example, the PUs 808 can communicate bus transaction requests to a memory controller 816, as an example of a slave device. Although not illustrated in FIG. 8, multiple system buses 814 could be provided, wherein each system bus 814 constitutes a different fabric.

Other master and slave devices can be connected to the system bus 814. As illustrated in FIG. 8, these devices can include a memory system 820 that includes the memory controller 816 and a memory array(s) 818, one or more input devices 822, one or more output devices 824, one or more network interface devices 826, and one or more display controllers 828 as examples. The input device(s) 822 can include any type of input device, including, but not limited to, input keys, switches, voice processors, etc. The output device(s) 824 can include any type of output device, including, but not limited to, audio, video, other visual indicators, etc. The network interface device(s) 826 can be any device configured to allow exchange of data to and from a network 830. The network 830 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 826 can be configured to support any type of communications protocol desired.

The PUs 808 may also be configured to access the display controller(s) 828 over the system bus 814 to control information sent to one or more displays 832. The display controller(s) 828 sends information to the display(s) 832 to be displayed via one or more video processors 834, which process the information to be displayed into a format suitable for the display(s) 832. The display controller(s) 828 and video processor(s) 834 can be included in the same or different ICs, or in the same IC 804 containing the PUS 808, as examples. The display(s) 832 can include any type of display, including, but not limited to, a cathode ray tube (CRT), a liquid crystal display (LCD), a plasma display, a light emitting diode (LED) display, etc.

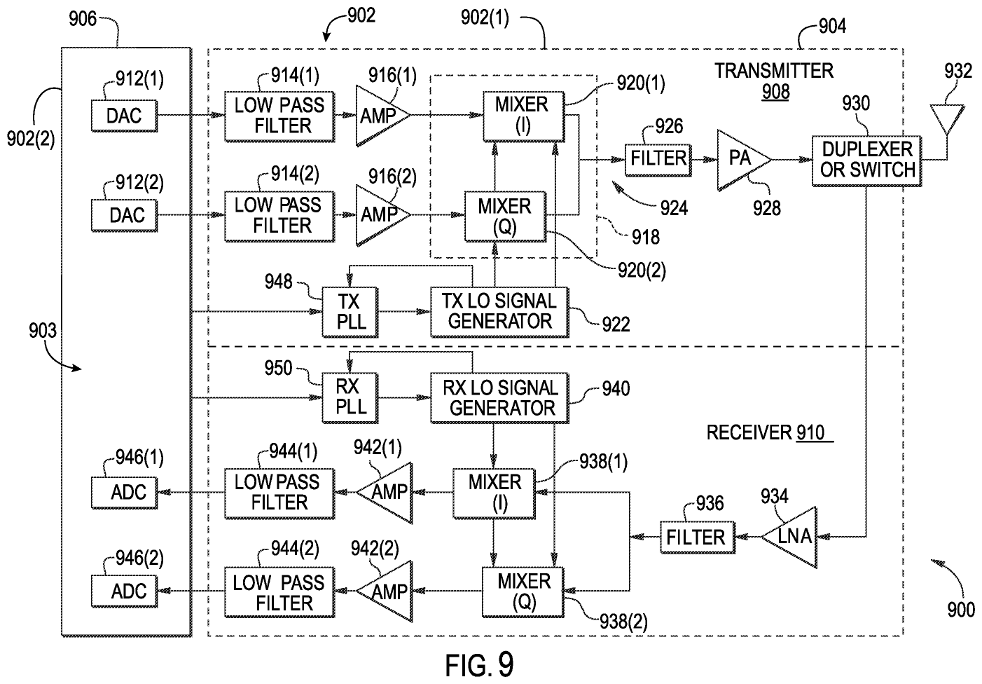

FIG. 9 illustrates an exemplary wireless communications device 900 that includes radio frequency (RF) components and that includes a power limiter circuit(s) 902, 902(1)-902(2) configured to determine a total processing unit power limit budget available to the processing units based on remaining power available to maintain the processor-based system within its overall power consumption limit, and allocate the total processing unit power limit budget to the processing units to control their power consumption based on their workloads being executed, and according to any of the exemplary processes 300, 500, 600 in FIGS. 3, 5, and 6, and that can include, but is not limited to, the processor-based system 100 in FIGS. 1 and 2 and/or power limiter circuit 134 in FIGS. 1 and 2, and according to any aspects disclosed herein. The wireless communications device 900 may include or be provided in any of the above-referenced devices, as examples. As shown in FIG. 9, the wireless communications device 900 includes a transceiver 904 and a data processor 906, each of which may include its own power limiter circuit 902(1), 902(2). The data processor 906 may include a memory to store data and program codes. The transceiver 904 includes a transmitter 908 and a receiver 910 that support bi-directional communications. In general, the wireless communications device 900 may include any number of transmitters 908 and/or receivers 910 for any number of communication systems and frequency bands. All or a portion of the transceiver 904 may be implemented on one or more analog ICs, RF ICs (RFICs), mixed-signal ICs, etc.

The transmitter 908 or the receiver 910 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 910. In the direct-conversion architecture, a signal is frequency-converted between RF and baseband in one stage. The super-heterodyne and direct-conversion architectures may use different circuit blocks and/or have different requirements. In the wireless communications device 900 in FIG. 9, the transmitter 908 and the receiver 910 are implemented with the direct-conversion architecture.

In the transmit path, the data processor 906 processes data to be transmitted and provides I and Q analog output signals to the transmitter 908. In the exemplary wireless communications device 900, the data processor 906 includes digital-to-analog converters (DACs) 912(1), 912(2) for converting digital signals generated by the data processor 906 into the I and Q analog output signals, e.g., I and Q output currents, for further processing.

Within the transmitter 908, lowpass filters 914(1), 914(2) filter the I and Q analog output signals, respectively, to remove undesired signals caused by the prior digital-to-analog conversion. Amplifiers (AMPs) 916(1), 916(2) amplify the signals from the lowpass filters 914(1), 914(2), respectively, and provide I and Q baseband signals. An upconverter 918 upconverts the I and Q baseband signals with I and Q transmit (TX) local oscillator (LO) signals through mixers 920(1), 920(2) from a TX LO signal generator 922 to provide an upconverted signal 924. A filter 926 filters the upconverted signal 924 to remove undesired signals caused by the frequency up-conversion as well as noise in a receive frequency band. A power amplifier (PA) 928 amplifies the upconverted signal 924 from the filter 926 to obtain the desired output power level and provides a transmit RF signal. The transmit RF signal is routed through a duplexer or switch 930 and transmitted via an antenna 932.

In the receive path, the antenna 932 receives signals transmitted by base stations and provides a received RF signal, which is routed through the duplexer or switch 930 and provided to a low noise amplifier (LNA) 934. The duplexer or switch 930 is designed to operate with a specific receive (RX)-to-TX duplexer frequency separation, such that RX signals are isolated from TX signals. The received RF signal is amplified by the LNA 934 and filtered by a filter 936 to obtain a desired RF input signal. Down-conversion mixers 938(1), 938(2) mix the output of the filter 936 with I and Q RX LO signals (i.e., LO_I and LO_Q) from an RX LO signal generator 940 to generate I and Q baseband signals. The I and Q baseband signals are amplified by AMPs 942(1), 942(2) and further filtered by lowpass filters 944(1), 944(2) to obtain I and Q analog input signals, which are provided to the data processor 906. In this example, the data processor 906 includes analog-to-digital converters (ADCs) 946(1), 946(2) for converting the analog input signals into digital signals to be further processed by the data processor 906.

In the wireless communications device 900 of FIG. 9, the TX LO signal generator 922 generates the I and Q TX LO signals used for frequency up-conversion, while the RX LO signal generator 940 generates the I and Q RX LO signals used for frequency down-conversion. Each LO signal is a periodic signal with a particular fundamental frequency. A TX phase-locked loop (PLL) circuit 948 receives timing information from the data processor 906 and generates a control signal used to adjust the frequency and/or phase of the TX LO signals from the TX LO signal generator 922. Similarly, an RX PLL circuit 950 receives timing information from the data processor 906 and generates a control signal used to adjust the frequency and/or phase of the RX LO signals from the RX LO signal generator 940.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device or processing unit, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A power limiter circuit for limiting power consumption of a plurality of processing units (PUs) in a processor-based system, configured to:
   (a) determine a total PU power limit budget based on a difference between an overall power limit for the processor-based system and a power usage in the processor-based system;
   (b) receive a plurality of workload data indicating a workload activity of each PU of a plurality of the PUS;
   (c) allocate a power limit budget from the total PU power limit budget for each PU of the plurality of PUs based on workload data of the plurality of workload data corresponding to each PU;
   (d) cause power consumption by each PU of the plurality of PUs to be constrained within the allocated power limit budget determined for the PU;
   (e) determine a difference between actual power consumption of each PU of the plurality of PUs and the power limit budget for each PU; and
   (f) reallocate a new power limit budget from the total PU power limit budget for each PU of the plurality of PUs based on the determined difference between the actual power consumption of each PU of the plurality of PUs and the power limit budget for each PU.
2. The power limiter circuit of clause 1, further configured to set an operating point for a PU of the plurality of PUs based on the allocated power limit budget for the PU.
3. The power limiter circuit of clause 1 or 2, further configured to reset the operating point for the PU of the plurality of PUs based on the reallocated new power limit budget for the PU.
4. The power limiter circuit of any of clauses 1-3, configured to:
   determine the difference between the actual power consumption of each PU of the plurality of PUs and the power limit budget for each PU, by being configured to:
      receive a first actual power consumption of a first PU of the plurality of PUS;
      compare the first actual power consumption to the power limit budget allocated to the first PU; and
      determine a difference between the first actual power consumption and the power limit budget allocated to the first PU; and
   reallocate the new power limit budget by being configured to:
      reallocate the new power limit budget from the total PU power limit budget for the first PU based on the determined difference between the first actual power consumption and the power limit budget allocated to the first PU; and
      reallocate at least one power limit budget for at least one second PU of the plurality of PUs from the total PU power limit budget based on a difference between the total PU power limit budget and the new power limit budget for the first PU.
5. The power limiter circuit of clause 4, configured to:
   determine the difference between the first actual power consumption and the power limit budget allocated to the first PU by being configured to determine if the first actual power consumption is less than the power limit budget allocated to the first PU;
   reallocate the new power limit budget from the total PU power limit budget for the first PU based on lowering the power limit budget for the first PU based on the determined difference between the first actual power consumption and the power limit budget allocated to the first PU; and
   reallocate the at least one power limit budget for the at least one second PU by being configured to increase the at least one power limit budget for the at least one second PU from the total PU power limit budget based on the difference between the total PU power limit budget and the new power limit budget for the first PU.
6. The power limiter circuit of clause 4 or 5, configured to:
   determine the difference between the first actual power consumption and the power limit budget allocated to the first PU by being configured to determine if the first actual power consumption is greater than the power limit budget allocated to the first PU;
   reallocate the new power limit budget from the total PU power limit budget for the first PU based on increasing the power limit budget for the first PU based on the determined difference between the first actual power consumption and the power limit budget allocated to the first PU; and
   reallocate the at least one power limit budget for the at least one second PU by being configured to decrease the at least one power limit budget for the at least one second PU from the total PU power limit budget based on the difference between the total PU power limit budget and the new power limit budget for the first PU.
7. The power limiter circuit of any of clauses 1-6, further configured to: receive a performance throttle event for a first PU of the plurality of PUs; and in response to receiving the performance throttle event for the first PU:
   reallocate the new power limit budget for the first PU lower than the power limit budget allocated to the first PU; and
   reallocate at least one new power limit budget for at least one second PU of the plurality of PUs based on a difference between the total PU power limit budget and the new power limit budget allocated to the first PU.
8. The power limiter circuit of any of clauses 1-7, further configured to:
   (e) monitor the actual power consumption comprising an average power consumption of each PU of the plurality of PUs; and
   (f) reallocate the new power limit budget from the total PU power limit budget for each PU of the plurality of PUs based on the monitored average power consumption of each PU of the plurality of PUs.
9. The power limiter circuit of any of clauses 1-8, further comprising a power budget weight distribution circuit configured to:
   (b) receive the plurality of workload data indicating the workload activity of each PU of the plurality of the PUs; and
   (c) allocate the power limit budget for each PU of the plurality of PUs by being configured to:
      determine a percentage weight of the total PU power limit budget for each PU of the plurality of PUs proportional to the workload activity of each PU to a total workload activity of the plurality of workload data of the plurality of PUs; and
      allocate the power limit budget from the total PU power limit budget for each PU of the plurality of PUs based on the percentage weight of each PU of the plurality of PUs.
10. The power limiter circuit of any of clauses 1-9, further comprising a memory comprising a plurality of power limit budget registers each configured to store the power limit budget for a PU of the plurality of PUS,
   wherein:
      the power limiter circuit is further configured to:
         store the allocated power limit budget for each PU of the plurality of PUs in a power limit budget register of the plurality of power limit budget registers assigned to the PU; and
         access the stored power limit budget for each PU of the plurality of PUs in the plurality of power limit budget registers; and
      the power limiter circuit is configured to cause the power consumption by each PU of the plurality of PUs to be constrained within the accessed stored power limit budget determined for each PU.
11. The power limiter circuit of any of clauses 1-10 configured to continuously repeat (a)-(f).
12. The power limiter circuit of clause 11 configured to continuously repeat (a)-(f) in response to expiration of a timer reset to a constant time.
13. The power limiter circuit of clause 11 or 12 configured to continuously repeat (a)-(f) in response to a power limiting budget interrupt.
14. The power limiter circuit of any of clauses 11-13 further configured to disable the continuous repeat of (a)-(f) in response to a PU disable signal indicating an inactive operation state of the plurality of PUs.
15. The power limiter circuit of any of clauses 11-14 further configured to enable the continuous repeat of (a)-(f) in response to a PU enable signal indicating an active operation state of the plurality of PUs.
16. The power limiting circuit of any of clauses 1-15, further configured to receive power telemetry data comprising the power usage in the processor-based system.
17. The power limiter circuit of clause 16, wherein the power telemetry data comprises power usage of a plurality of non-PU power consuming devices in the processor-based system.
18. The power limiter circuit of any of clauses 1-17, further comprising:
   a power limit budget determination circuit configured to:
      (a) determine the total PU power limit budget based on the difference between the overall power limit for the processor-based system and the power usage;
   a power limit budget allocation circuit configured to:
      (b) receive the plurality of workload data indicating the workload activity of each PU of the plurality of the PUS;
   a power limit budget circuit configured to:
      (c) allocate the power limit budget from the total PU power limit budget for each PU of the plurality of PUs based on the workload data of the plurality of workload data corresponding to each PU; and
      (d) cause the power consumption by each PU of the plurality of PUs to be constrained within the allocated power limit budget determined for each PU;
   a power consumption differential circuit configured to:
      (e) determine the difference between the actual power consumption of each PU of the plurality of PUs and the power limit budget for each PU; and the power limit budget allocation circuit further configured to:
      (f) reallocate the new power limit budget from the total PU power limit budget for each PU of the plurality of PUs based on the determined difference between the actual power consumption of each PU of the plurality of PUs and the power limit budget for each PU.
19. The power limiter circuit of any of clauses 1-18 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
20. A method of limiting power consumption of a plurality of processing units (Pus) in a processor-based system, comprising:
   (a) determining a total PU power limit budget based on a difference between an overall power limit for the processor-based system and a power usage in the processor-based system;
   (b) receiving a plurality of workload data indicating a workload activity of each PU of a plurality of the Pus;
   ϵ allocating a power limit budget from the total PU power limit budget for each PU of the plurality of Pus based on workload data of the plurality of workload data corresponding to each PU;
   (d) causing power consumption by each PU of the plurality of Pus to be constrained within the allocated power limit budget determined for the PU;
   ϵ determining a difference between actual power consumption of each PU of the plurality of Pus and the power limit budget for each PU; and
   (f) reallocating a new power limit budget from the total PU power limit budget for each PU of the plurality of Pus based on the determined difference between the actual power consumption of each PU of the plurality of Pus and the power limit budget for each PU.
21. The method of clause 20, wherein causing the power consumption by each PU of the plurality of PUs to be constrained within the power limit budget determined for each PU comprises:
   setting an operating point for a PU of the plurality of PUs based on the allocated power limit budget for the PU.
22. The method of clause 20 or 21, further comprising resetting the operating point for the PU of the plurality of PUs based on the reallocated new power limit budget for the PU.
23. The method of any of clauses 20-22, wherein:
determining the difference between the actual power consumption of each PU of the plurality of PUs and the power limit budget for each PU comprises:
   receiving a first actual power consumption of a first PU of the plurality of PUS;
      comparing the first actual power consumption to the power limit budget allocated to the first PU; and
      determining a difference between the first actual power consumption and the power limit budget allocated to the first PU; and
   reallocating the new power limit budget comprises:
      reallocating the new power limit budget from the total PU power limit budget for the first PU based on the determined difference between the first actual power consumption and the power limit budget allocated to the first PU; and
      reallocating at least one power limit budget for at least one second PU of the plurality of PUs from the total PU power limit budget based on a difference between the total PU power limit budget and the new power limit budget for the first PU.
24. The method of clause 23, comprising:
   determining the difference between the first actual power consumption and the power limit budget allocated to the first PU by being configured to determine if the first actual power consumption is less than the power limit budget allocated to the first PU;
   reallocating the new power limit budget from the total PU power limit budget for the first PU based on lowering the power limit budget for the first PU based on the determined difference between the first actual power consumption and the power limit budget allocated to the first PU; and
   reallocating the at least one power limit budget for the at least one second PU by being configured to increase the at least one power limit budget for the at least one second PU from the total PU power limit budget based on the difference between the total PU power limit budget and the new power limit budget for the first PU.
25. The method of clause 23 or 24, comprising:
   determining the difference between the first actual power consumption and the power limit budget allocated to the first PU by being configured to determine if the first actual power consumption is greater than the power limit budget allocated to the first PU;
   reallocating the new power limit budget from the total PU power limit budget for the first PU based on increasing the power limit budget for the first PU based on the determined difference between the first actual power consumption and the power limit budget allocated to the first PU; and
   reallocating the at least one power limit budget for the at least one second PU by being configured to decrease the at least one power limit budget for the at least one second PU from the total PU power limit budget based on the difference between the total PU power limit budget and the new power limit budget for the first PU.
26. The method of any of clauses 20-25, further comprising:
   receiving a performance throttle event for a first PU of the plurality of PUs; and in response to receiving the performance throttle event for the first PU: reallocating the new power limit budget for the first PU lower than the power limit budget allocated to the first PU; and
   reallocating at least one new power limit budget for at least one second PU of the plurality of PUs based on a difference between the total PU power limit budget and the new power limit budget allocated to the first PU.
27. The method of any of clauses 20-26, further comprising:
   (e) monitoring the actual power consumption comprising an average power consumption of each PU of the plurality of PUs; and
   (f) reallocating the new power limit budget from the total PU power limit budget for each PU of the plurality of PUs based on the monitored average power consumption of each PU of the plurality of PUs.
28. The method of any of clauses 20-27, further comprising continuously repeating (a)-(f).
29. The power limiting circuit of any of clauses 20-28, further configured to receive power telemetry data comprising the power usage in the processor-based system.
30. The method of clause 29, wherein the power telemetry data comprises power usage of a plurality of non-PU power consuming devices in the processor-based system.
31. A processor-based system, comprising:
   a plurality of non-processing unit (PU) power consuming devices;
   a plurality of processing units (PUS);
   a plurality of PU performance monitor circuits each configured to:
      monitor workload activity of a PU of the plurality of PUS;
      generate workload data corresponding to the monitored workload activity of the PU of the plurality of PUS;
   a plurality of power monitoring circuits each configured to monitor actual power consumption of a PU of the plurality of PUs;
   a plurality of power constraining circuits each configured to constrain power consumption of a PU of the plurality of PUs; and
   a power limiter circuit, configured to:
      (a) determine a total PU power limit budget based on a difference between an overall power limit for the processor-based system and a power usage of the plurality of non-PU power consuming devices;
      (b) allocate a power limit budget from the total PU power limit budget for each PU of the plurality of PUs based on the workload data corresponding to each PU;
      (c) instruct each of the plurality of power constraining circuits to constrain the power consumption of a PU of the plurality of PUs within the allocated power limit budget for the PU;
      (d) determine a difference between the actual power consumption of each PU of the plurality of PUs from the plurality of power monitoring circuits and the power limit budget for each PU; and
      (e) reallocate a new power limit budget from the total PU power limit budget for each PU of the plurality of PUs based on the determined difference between the actual power consumption of each PU of the plurality of PUs and the power limit budget for each PU.
32. The processor-based system of clause 31, comprising:
   a dynamic voltage frequency scaling (DVFS) circuit configured to set an operating frequency and voltage for operation of a PU of the plurality of PUS;
   the power limiter circuit further configured to:
      set an operating point for a PU of the plurality of PUs in the DVFS circuit based on the allocated power limit budget for the PU of the plurality of PUs.
33. The processor-based system of clause 31 or 32, wherein the power limiter circuit is further configured to reset the operating point for the DVFS circuit of a plurality of DVFS circuits for a PU of the plurality of PUs based the reallocated new power limit budget for the PU.
34. The processor-based system of any of clauses 31-33, wherein the power limiter circuit is configured to:
   determine the difference between the actual power consumption of each PU of the plurality of PUs and the power limit budget for each PU, by being configured to:
      receive a first actual power consumption of a first PU of the plurality of PUs from a power monitoring circuit of the plurality of power monitoring circuits configured to monitor the actual power consumption of the first PU;
      compare the first actual power consumption to the power limit budget allocated to the first PU; and
      determine a difference between the first actual power consumption and the power limit budget allocated to the first PU; and
   reallocate the new power limit budget by being configured to:
      reallocate the new power limit budget from the total PU power limit budget for the first PU based on the determined difference between the first actual power consumption and the power limit budget allocated to the first PU; and
      reallocate at least one power limit budget for at least one second PU of the plurality of PUs from the total PU power limit budget based on a difference between the total PU power limit budget and the new power limit budget for the first PU.
35. The processor-based system of clause 34, wherein the power limiter circuit is configured to:
   determine the difference between the first actual power consumption and the power limit budget allocated to the first PU by being configured to determine if the first actual power consumption is less than the power limit budget allocated to the first PU;
   reallocate the new power limit budget from the total PU power limit budget for the first PU based on lowering the power limit budget for the first PU based on the determined difference between the first actual power consumption and the power limit budget allocated to the first PU; and
   reallocate the at least one power limit budget for the at least one second PU by being configured to increase the at least one power limit budget for the at least one second PU from the total PU power limit budget based on the difference between the total PU power limit budget and the new power limit budget for the first PU.
36. The processor-based system of clause 34 or 35, wherein the power limiter circuit is configured to:
   determine the difference between the first actual power consumption and the power limit budget allocated to the first PU by being configured to determine if the first actual power consumption is greater than the power limit budget allocated to the first PU;
   reallocate the new power limit budget from the total PU power limit budget for the first PU based on increasing the power limit budget for the first PU based on the determined difference between the first actual power consumption and the power limit budget allocated to the first PU; and
   reallocate the at least one power limit budget for the at least one second PU by being configured to decrease the at least one power limit budget for the at least one second PU from the total PU power limit budget based on the difference between the total PU power limit budget and the new power limit budget for the first PU.
37. The processor-based system of any of clauses 31-36, further comprising:
   a plurality of power consumption comparator circuits each configured to:
      generate a power difference signal between the power limit budget of a PU of the plurality of PUs and the actual power consumption of the PU of the plurality of PUs; and
   a plurality of performance throttle circuits each configured to:
      generate a performance throttle event to cause performance of a PU of the plurality of PUs to be throttled based on the power difference signal indicating the actual power consumption of the PU exceeds the power limit budget of the PU;
   the power limiter circuit further configured to:
      receive the performance throttle event for a first PU of the plurality of PUs; and
      in response to receiving the performance throttle event for the first PU:
         reallocate the new power limit budget for the first PU lower than the power limit budget allocated to the first PU; and
         reallocate at least one new power limit budget for at least one second PU of the plurality of PUs based on a difference between the total PU power limit budget and the new power limit budget allocated to the first PU.
38. The processor-based system of any of clauses 31-37, wherein:
   each power monitoring circuit of the plurality of power monitoring circuits is configured to monitor an average power consumption of a PU of the plurality of PUs; and
   the power limiter circuit is configured to reallocate the new power limit budget from the total PU power limit budget for each PU of the plurality of PUS based on the monitored average power consumption of each PU of the plurality of PUs.
39. The processor-based system of any of clauses 31-38, wherein the power limiter circuit is configured to continuously repeat (a)-(e).
40. The processor-based system of any of clauses 31-39 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

What is claimed is:

1. A power limiter circuit for limiting power consumption of a plurality of processing units (PUs) in a processor-based system, configured to:
(a) determine a total PU power limit budget based on a difference between an overall power limit for the processor-based system and a power usage in the processor-based system;
(b) receive a plurality of workload data indicating a workload activity of each PU of a plurality of the PUS;
(c) allocate a power limit budget from the total PU power limit budget for each PU of the plurality of PUs based on workload data of the plurality of workload data corresponding to each PU;
(d) cause power consumption by each PU of the plurality of PUs to be constrained within the allocated power limit budget determined for the PU;
(e) determine a difference between actual power consumption of each PU of the plurality of PUs and the power limit budget for each PU; and
(f) reallocate a new power limit budget from the total PU power limit budget for each PU of the plurality of PUs based on the determined difference between the actual power consumption of each PU of the plurality of PUs and the power limit budget for each PU.

2. The power limiter circuit of claim 1, further configured to set an operating point for a PU of the plurality of PUs based on the allocated power limit budget for the PU.

3. The power limiter circuit of claim 2, further configured to reset the operating point for the PU of the plurality of PUs based on the reallocated new power limit budget for the PU.

4. The power limiter circuit of claim 1, configured to:
determine the difference between the actual power consumption of each PU of the plurality of PUs and the power limit budget for each PU, by being configured to:
receive a first actual power consumption of a first PU of the plurality of PUS;
compare the first actual power consumption to the power limit budget allocated to the first PU; and
determine a difference between the first actual power consumption and the power limit budget allocated to the first PU; and
reallocate the new power limit budget by being configured to:
reallocate the new power limit budget from the total PU power limit budget for the first PU based on the determined difference between the first actual power consumption and the power limit budget allocated to the first PU; and
reallocate at least one power limit budget for at least one second PU of the plurality of PUs from the total PU power limit budget based on a difference between the total PU power limit budget and the new power limit budget for the first PU.

5. The power limiter circuit of claim 4, configured to:
determine the difference between the first actual power consumption and the power limit budget allocated to the first PU by being configured to determine if the first actual power consumption is less than the power limit budget allocated to the first PU;
reallocate the new power limit budget from the total PU power limit budget for the first PU based on lowering the power limit budget for the first PU based on the determined difference between the first actual power consumption and the power limit budget allocated to the first PU; and
reallocate the at least one power limit budget for the at least one second PU by being configured to increase the at least one power limit budget for the at least one second PU from the total PU power limit budget based on the difference between the total PU power limit budget and the new power limit budget for the first PU.

6. The power limiter circuit of claim 4, configured to:
determine the difference between the first actual power consumption and the power limit budget allocated to the first PU by being configured to determine if the first actual power consumption is greater than the power limit budget allocated to the first PU;
reallocate the new power limit budget from the total PU power limit budget for the first PU based on increasing the power limit budget for the first PU based on the determined difference between the first actual power consumption and the power limit budget allocated to the first PU; and
reallocate the at least one power limit budget for the at least one second PU by being configured to decrease the at least one power limit budget for the at least one second PU from the total PU power limit budget based on the difference between the total PU power limit budget and the new power limit budget for the first PU.

7. The power limiter circuit of claim 1, further configured to:
receive a performance throttle event for a first PU of the plurality of PUs; and
in response to receiving the performance throttle event for the first PU:
reallocate the new power limit budget for the first PU lower than the power limit budget allocated to the first PU; and
reallocate at least one new power limit budget for at least one second PU of the plurality of PUs based on a difference between the total PU power limit budget and the new power limit budget allocated to the first PU.

8. The power limiter circuit of claim 1, further configured to:
(e) monitor the actual power consumption comprising an average power consumption of each PU of the plurality of PUs; and
(f) reallocate the new power limit budget from the total PU power limit budget for each PU of the plurality of PUs based on the monitored average power consumption of each PU of the plurality of PUs.

9. The power limiter circuit of claim 1, further comprising a power budget weight distribution circuit configured to:
(b) receive the plurality of workload data indicating the workload activity of each PU of the plurality of the PUs; and
(c) allocate the power limit budget for each PU of the plurality of PUs by being configured to:
determine a percentage weight of the total PU power limit budget for each PU of the plurality of PUs proportional to the workload activity of each PU to a total workload activity of the plurality of workload data of the plurality of PUs; and
allocate the power limit budget from the total PU power limit budget for each PU of the plurality of PUs based on the percentage weight of each PU of the plurality of PUS.

10. The power limiter circuit of claim 1, further comprising a memory comprising a plurality of power limit budget registers each configured to store the power limit budget for a PU of the plurality of PUs,
wherein:
the power limiter circuit is further configured to:
store the allocated power limit budget for each PU of the plurality of PUs in a power limit budget register of the plurality of power limit budget registers assigned to the PU; and
access the stored power limit budget for each PU of the plurality of PUs in the plurality of power limit budget registers; and
the power limiter circuit is configured to cause the power consumption by each PU of the plurality of PUs to be constrained within the accessed stored power limit budget determined for each PU.

11. The power limiter circuit of claim 1 configured to continuously repeat (a)-(f).

12. The power limiter circuit of claim 11 configured to continuously repeat (a)-(f) in response to expiration of a timer reset to a constant time.

13. The power limiter circuit of claim 11 configured to continuously repeat (a)-(f) in response to a power limiting budget interrupt.

14. The power limiter circuit of claim 11 further configured to disable the continuous repeat of (a)-(f) in response to a PU disable signal indicating an inactive operation state of the plurality of PUs.

15. The power limiter circuit of claim 11 further configured to enable the continuous repeat of (a)-(f) in response to a PU enable signal indicating an active operation state of the plurality of PUs.

16. The power limiting circuit of claim 1, further configured to receive power telemetry data comprising the power usage in the processor-based system.

17. The power limiter circuit of claim 16, wherein the power telemetry data comprises power usage of a plurality of non-PU power consuming devices in the processor-based system.

18. The power limiter circuit of claim 1, further comprising:
a power limit budget determination circuit configured to:
(a) determine the total PU power limit budget based on the difference between the overall power limit for the processor-based system and the power usage;
a power limit budget allocation circuit configured to:
(b) receive the plurality of workload data indicating the workload activity of each PU of the plurality of the PUs;
a power limit budget circuit configured to:
(c) allocate the power limit budget from the total PU power limit budget for each PU of the plurality of PUs based on the workload data of the plurality of workload data corresponding to each PU; and
(d) cause the power consumption by each PU of the plurality of PUs to be constrained within the allocated power limit budget determined for each PU;
a power consumption differential circuit configured to:
(e) determine the difference between the actual power consumption of each PU of the plurality of PUs and the power limit budget for each PU; and
the power limit budget allocation circuit further configured to:
(f) reallocate the new power limit budget from the total PU power limit budget for each PU of the plurality of PUs based on the determined difference between the actual power consumption of each PU of the plurality of PUs and the power limit budget for each PU.

19. The power limiter circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

20. A method of limiting power consumption of a plurality of processing units (PUs) in a processor-based system, comprising:
(a) determining a total PU power limit budget based on a difference between an overall power limit for the processor-based system and a power usage in the processor-based system;
(b) receiving a plurality of workload data indicating a workload activity of each PU of a plurality of the PUS;
(c) allocating a power limit budget from the total PU power limit budget for each PU of the plurality of PUs based on workload data of the plurality of workload data corresponding to each PU;
(d) causing power consumption by each PU of the plurality of PUs to be constrained within the allocated power limit budget determined for the PU;
(e) determining a difference between actual power consumption of each PU of the plurality of PUs and the power limit budget for each PU; and
(f) reallocating a new power limit budget from the total PU power limit budget for each PU of the plurality of PUs based on the determined difference between the actual power consumption of each PU of the plurality of PUs and the power limit budget for each PU.

21. The method of claim 20, wherein causing the power consumption by each PU of the plurality of PUs to be constrained within the power limit budget determined for each PU comprises:
setting an operating point for a PU of the plurality of PUs based on the allocated power limit budget for the PU.

22. The method of claim 21, further comprising resetting the operating point for the PU of the plurality of PUs based on the reallocated new power limit budget for the PU.

23. The method of claim 20, wherein:
determining the difference between the actual power consumption of each PU of the plurality of PUs and the power limit budget for each PU comprises:
receiving a first actual power consumption of a first PU of the plurality of PUS;
comparing the first actual power consumption to the power limit budget allocated to the first PU; and
determining a difference between the first actual power consumption and the power limit budget allocated to the first PU; and
reallocating the new power limit budget comprises:
reallocating the new power limit budget from the total PU power limit budget for the first PU based on the determined difference between the first actual power consumption and the power limit budget allocated to the first PU; and
reallocating at least one power limit budget for at least one second PU of the plurality of PUs from the total PU power limit budget based on a difference between the total PU power limit budget and the new power limit budget for the first PU.

24. The method of claim 23, comprising:
determining the difference between the first actual power consumption and the power limit budget allocated to the first PU by being configured to determine if the first actual power consumption is less than the power limit budget allocated to the first PU;
reallocating the new power limit budget from the total PU power limit budget for the first PU based on lowering the power limit budget for the first PU based on the determined difference between the first actual power consumption and the power limit budget allocated to the first PU; and
reallocating the at least one power limit budget for the at least one second PU by being configured to increase the at least one power limit budget for the at least one second PU from the total PU power limit budget based on the difference between the total PU power limit budget and the new power limit budget for the first PU.

25. The method of claim 23, comprising:
determining the difference between the first actual power consumption and the power limit budget allocated to the first PU by being configured to determine if the first actual power consumption is greater than the power limit budget allocated to the first PU;
reallocating the new power limit budget from the total PU power limit budget for the first PU based on increasing the power limit budget for the first PU based on the determined difference between the first actual power consumption and the power limit budget allocated to the first PU; and
reallocating the at least one power limit budget for the at least one second PU by being configured to decrease the at least one power limit budget for the at least one second PU from the total PU power limit budget based on the difference between the total PU power limit budget and the new power limit budget for the first PU.

26. The method of claim 20, further comprising:
receiving a performance throttle event for a first PU of the plurality of PUs; and
in response to receiving the performance throttle event for the first PU:
reallocating the new power limit budget for the first PU lower than the power limit budget allocated to the first PU; and
reallocating at least one new power limit budget for at least one second PU of the plurality of PUs based on a difference between the total PU power limit budget and the new power limit budget allocated to the first PU.

27. The method of claim 20, further comprising:
(e) monitoring the actual power consumption comprising an average power consumption of each PU of the plurality of PUs; and
(f) reallocating the new power limit budget from the total PU power limit budget for each PU of the plurality of PUs based on the monitored average power consumption of each PU of the plurality of PUs.

28. The method of claim 20, further comprising continuously repeating (a)-(f).

29. The power limiting circuit of claim 20, further configured to receive power telemetry data comprising the power usage in the processor-based system.

30. The method of claim 29, wherein the power telemetry data comprises power usage of a plurality of non-PU power consuming devices in the processor-based system.

31. A processor-based system, comprising:
a plurality of non-processing unit (PU) power consuming devices;
a plurality of processing units (PUs);
a plurality of PU performance monitor circuits each configured to:
monitor workload activity of a PU of the plurality of PUS;
generate workload data corresponding to the monitored workload activity of the PU of the plurality of PUS;
a plurality of power monitoring circuits each configured to monitor actual power consumption of a PU of the plurality of PUs;
a plurality of power constraining circuits each configured to constrain power consumption of a PU of the plurality of PUs; and
a power limiter circuit, configured to:
(a) determine a total PU power limit budget based on a difference between an overall power limit for the processor-based system and a power usage of the plurality of non-PU power consuming devices;
(b) allocate a power limit budget from the total PU power limit budget for each PU of the plurality of PUs based on the workload data corresponding to each PU;
(c) instruct each of the plurality of power constraining circuits to constrain the power consumption of a PU of the plurality of PUs within the allocated power limit budget for the PU;
(d) determine a difference between the actual power consumption of each PU of the plurality of PUs from the plurality of power monitoring circuits and the power limit budget for each PU; and
(e) reallocate a new power limit budget from the total PU power limit budget for each PU of the plurality of PUs based on the determined difference between the actual power consumption of each PU of the plurality of PUs and the power limit budget for each PU.

32. The processor-based system of claim 31, comprising:
a dynamic voltage frequency scaling (DVFS) circuit configured to set an operating frequency and voltage for operation of a PU of the plurality of PUS;
the power limiter circuit further configured to:
set an operating point for a PU of the plurality of PUs in the DVFS circuit based on the allocated power limit budget for the PU of the plurality of PUs.

33. The processor-based system of claim 32, wherein the power limiter circuit is further configured to reset the operating point for the DVFS circuit of a plurality of DVFS circuits for a PU of the plurality of PUs based the reallocated new power limit budget for the PU.

34. The processor-based system of claim 31, wherein the power limiter circuit is configured to:
determine the difference between the actual power consumption of each PU of the plurality of PUs and the power limit budget for each PU, by being configured to:
receive a first actual power consumption of a first PU of the plurality of PUs from a power monitoring circuit of the plurality of power monitoring circuits configured to monitor the actual power consumption of the first PU;
compare the first actual power consumption to the power limit budget allocated to the first PU; and
determine a difference between the first actual power consumption and the power limit budget allocated to the first PU; and
reallocate the new power limit budget by being configured to:
reallocate the new power limit budget from the total PU power limit budget for the first PU based on the determined difference between the first actual power consumption and the power limit budget allocated to the first PU; and
reallocate at least one power limit budget for at least one second PU of the plurality of PUs from the total PU power limit budget based on a difference between the total PU power limit budget and the new power limit budget for the first PU.

35. The processor-based system of claim 34, wherein the power limiter circuit is configured to:
determine the difference between the first actual power consumption and the power limit budget allocated to the first PU by being configured to determine if the first actual power consumption is less than the power limit budget allocated to the first PU;
reallocate the new power limit budget from the total PU power limit budget for the first PU based on lowering the power limit budget for the first PU based on the determined difference between the first actual power consumption and the power limit budget allocated to the first PU; and
reallocate the at least one power limit budget for the at least one second PU by being configured to increase the at least one power limit budget for the at least one second PU from the total PU power limit budget based on the difference between the total PU power limit budget and the new power limit budget for the first PU.

36. The processor-based system of claim 34, wherein the power limiter circuit is configured to:
determine the difference between the first actual power consumption and the power limit budget allocated to the first PU by being configured to determine if the first actual power consumption is greater than the power limit budget allocated to the first PU;
reallocate the new power limit budget from the total PU power limit budget for the first PU based on increasing the power limit budget for the first PU based on the determined difference between the first actual power consumption and the power limit budget allocated to the first PU; and
reallocate the at least one power limit budget for the at least one second PU by being configured to decrease the at least one power limit budget for the at least one second PU from the total PU power limit budget based on the difference between the total PU power limit budget and the new power limit budget for the first PU.

37. The processor-based system of claim 31, further comprising:
a plurality of power consumption comparator circuits each configured to:
generate a power difference signal between the power limit budget of a PU of the plurality of PUs and the actual power consumption of the PU of the plurality of PUs; and
a plurality of performance throttle circuits each configured to:
generate a performance throttle event to cause performance of a PU of the plurality of PUs to be throttled based on the power difference signal indicating the actual power consumption of the PU exceeds the power limit budget of the PU;
the power limiter circuit further configured to:
receive the performance throttle event for a first PU of the plurality of PUs; and
in response to receiving the performance throttle event for the first PU:
reallocate the new power limit budget for the first PU lower than the power limit budget allocated to the first PU; and
reallocate at least one new power limit budget for at least one second PU of the plurality of PUs based on a difference between the total PU power limit budget and the new power limit budget allocated to the first PU.

38. The processor-based system of claim 31, wherein:
each power monitoring circuit of the plurality of power monitoring circuits is configured to monitor an average power consumption of a PU of the plurality of PUs; and
the power limiter circuit is configured to reallocate the new power limit budget from the total PU power limit budget for each PU of the plurality of PUs based on the monitored average power consumption of each PU of the plurality of PUs.

39. The processor-based system of claim 31, wherein the power limiter circuit is configured to continuously repeat (a)-(e).

40. The processor-based system of claim 32 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
